(19) United States
(12) Patent Application Publication
(10) Pub. No.: US 2021/0320415 A1
(43) Pub. Date: Oct. 14, 2021

(54) MICROWAVE ANTENNA SYSTEM WITH THREE-WAY POWER DIVIDERS/COMBINERS

(71) Applicant: Sonia Calzuola, Monaco (MC)

(72) Inventor: Sonia Calzuola, Monaco (MC)

(73) Assignee: Sonia Calzuola, Monaco (MC)

(21) Appl. No.: 17/265,188

(22) PCT Filed: Jul. 31, 2019
(86) PCT No.: PCT/EP2019/070737

§ 371 Date: Feb. 1, 2021

(30) Foreign Application Priority Data
Jul. 31, 2018 (GB) 1812518.7

(51) Int. Cl. H01Q 5/55; H01Q 13/02; H01Q 21/00; H01Q 21/06

(52) U.S. Cl. CPC H01Q 5/55; H01Q 13/0258; H01Q 13/0241; H01Q 21/064; H01Q 21/0006

(57) ABSTRACT

The invention relates to a radiating element (1) for receiving and transmitting microwave signals in a lower frequency band (RX) and a higher frequency band (TX). The radiating element (1) comprises a septum polarizer (4) for transmitting and/or receiving a frequency band in a first polarization and for transmitting and/or receiving a frequency band in a second polarization that is orthogonal to the first polarization. Waveguides feeding the radiating elements have a fundamental mode cut-off frequency and a higher mode cut-off frequency. The invention proposes to adapt the fundamental mode cut-off frequency and the septum geometry such that as top frequency band, created by a short septum length, ends below the higher frequency band (TX).

### TECHNICAL FIELD OF THE INVENTION

The invention relates to a dual orthogonal circularly polarized radiating element for a microwave transceiver, wherein the microwave transceiver transmits microwaves of a first frequency band and receives microwaves of a second frequency band. Such radiating elements comprise a radiating element waveguide and a septum polarizer extending in axial direction of the radiating element dividing the radiating element waveguide in a first subsection and a second subsection. The invention relates in particular to an antenna arrangement comprising a plurality of radiating elements for communications with satellites, particularly operating in the Ku-band or Ka-band.

### TECHNICAL BACKGROUND

Examples for frequencies used for satellite communication are the so-called X-Ku band, more commonly referred to as Ku band, which spans from 10.7 to 14.5 GHz, or a free-space wavelength of 20.7 mm to 28 mm respectively and the K-Ka band, commonly referred to as Ka band, which spans from 18 to 31 GHz, or a free-space wavelength of 9.7 mm to 16.7 mm, respectively.

As a function of the dimensions of the cross section of a waveguide, waveguides will only carry or propagate signals above a certain frequency, known as the cut-off frequency. Signals can progress along a waveguide using a number of modes. However the dominant mode is the one that has the lowest cut-off frequency. For a rectangular waveguide this is the TE₁₀ mode and for a circular waveguide this is the TE₁₁ mode. Below the waveguide cut-off frequency, signals will no longer propagate, but they will be exponentially attenuated. As it is known the cut-off frequency f_{cut-off} of the TE₁₀ mode in a square waveguide filled with air is the speed of light c₀ in vacuum divided by two times the width a_{□} of the square waveguide.

$${f}_{cut - off} = \frac{{c}_{0}}{2 {a}_{•}}$$

Similarly the cut-off frequency f_{cut-off} of the TE₁₁ mode in a circular waveguide is

$${f}_{cut - off} = \frac{1.8 \; 412 {c}_{0}}{π {a}_{o}}$$

wherein c₀ again is the speed of light in vacuum and aₒ is the diameter of the circular waveguide.

From U.S. Pat. No. 6,839,037 B1 a dual circular waveguide is known, which has a septum, which divides the waveguide into two separate compartments. The septum is proportioned and dimensioned to receive and convert the left and right hand circularly polarized signals into substantially linearly polarized signals as the signals pass along the waveguide past the septum. The waveguide system works in a frequency band of 11.7-12.7 GHz and covers a bandwidth of 1 GHz. The fractional bandwidth, i.e. the bandwidth divided by its centre frequency of this waveguide system therefore is 1.0 GHz/12.2 GHz=8.2%. As the cut-off frequency of this square waveguide of 15 mm is 10 GHz, the antenna works in a frequency band that is 117% to 122% of the cut-off frequency of the fundamental mode. According to this disclosure the septum is preferably stepped, but alternatively the spectrum may be non-stepped with a smooth, i.e. continuously curved edge. According to FIG. 11b of U.S. Pat. No. 6,839,037 B1 the waveguide is 15 mm wide and the length of the continuously curved edge in axial direction of the septum is 32 mm. This corresponds to an angle of tan(15 mm/32 mm) of approximately 25°.

From U.S. Pat. No. 3,955,202 a circularly polarized wave energy launcher is known, which utilizes a hollow waveguide terminated by a horn, which flares out from the waveguide. Within that structure, a septum fin extends from the waveguide into the horn. The septum divides the hollow waveguide into two smaller waveguides, each of which capable of independently supporting the TE₁₀ mode of wave propagation. The fin is a tapered plate that has its maximum width within the waveguide and its minimum width in the horn. A signal injected into one port of the divided waveguide emerges from the horn as a circularly polarized wave having its polarization vector rotating clockwise whereas a signal injected into the other port emerges from the horn as a circularly polarized wave with its polarization vector rotating in the counter clockwise direction.

This known wave energy launcher operates at 10.525 GHz with a 5% fractional bandwidth. The waveguide with a 25.4 mm long section of a square waveguide has internal dimensions of 20.3 mm times 20.3 mm. The septum fin is tapered at an angle ϕ of 26° over a length L of 30.1 mm. The cut-off frequency of a square waveguide with 20.3 mm width is 7.4 GHz. Therefore this energy launcher therefore operates at a range of 135% to 142% of the cut-off frequency of the dominant mode. While the preferred embodiment of this disclosure employs a square waveguide another embodiment in this disclosure shows a waveguide having a conical horn.

### OBJECT OF THE INVENTION

Known antenna arrangements have a limited bandwidth. IEEE defines bandwidth as “the range of frequencies within which the performance of the antenna, with respect to some characteristic, conforms to a specified standard”. In the context of this application bandwidth is defined as a continuous range of frequencies within which the antenna has sufficient performance for the intended use in a microwave duplex communication system. As an example, with a given transceiver designs the following minimum parameters may have to be met cumulatively as a requirement for a sufficient communication quality and therefore are called target parameters:

a) input return loss S₁₁<−10 dB

b) isolation S₂₁<−10 dB

c) cross-polarization discrimination XPD<−15 dB

Input return loss S₁₁ and isolation S₂₁ are so-called scattering parameters to measure the performance of a duplex antenna. The input return loss S₁₁ expressed in dB as the ratio 10 log₁₀(Pᵣ/Pᵢ) how much of the input power Pᵢ of an antenna port is reflected to the same antenna port as Pᵣ. The isolation S₂₁ expressed in dB as the ratio 10 log₁₀(P₂/P₁) how much of an input power of a first port P₁ is transmitted to the second port P₂. Cross polarization discrimination XPD is defined as a ratio of the co-polar component of the specified polarization compared to the orthogonal cross-polar component in the main beam pointing direction. Cross-polar discrimination XPD expresses the microwave antenna's ability to maintain radiated or received polarization purity between orthogonally polarized signals. A high cross-polar discrimination figure XPD means a cleaner signal in co-located transmission environments.

In the following we use “S₁₁” as a reference sign for input return loss, “S₂₁” as a reference sign for isolation and “XPD” as a reference sign for cross-polarization discrimination. However, the values for these parameters are used by some authors in the same way and by some authors with inverted values. We therefore define that within this document for example a value of 13 dB for input return loss is equivalent to a value of −13 dB for S₁₁. A input return loss of 13 dB means that the reflected signal (returning back from the input port, hence “return”, is 13 dB lower than the input signal, as if the input signal has been “attenuated” by a “loss” of 13 dB. This is why we in this document input return loss is defined as positive number, as it indicates the equivalent loss in the signal. Similarly, a value of 13 dB for isolation is equivalent to a value of −13 dB for S₂₁; and a value of 13 dB for cross-polarization discrimination is equivalent to a value of −13 dB for XPD. Further the words “improve” or “better than” in connection with the parameters S₁₁, S₂₁ and XPD shall indicate that the values for S₁₁ S₂₁ and XPD change from a negative value to a more negative value, for example change from −10 dB to −15 dB. Conversely, the words “degrade”, “deteriorate” or “worse than” shall indicate that the values for S₁₁, S₂₁ and XPD change from a negative value to a less negative value, for example change from −10 dB to −8 dB.

As the person skilled in the art will readily appreciate antenna gain can easily be increased at the cost of size and weight by adding more radiation elements, whereas there is no easy way to improve insufficient input return loss S₁₁, isolation S₂₁, or cross polarization discrimination XPD performance.

Typically, in Ku-band, a bandwidth of 2 GHz is used in downlink, i.e. transmitting from a satellite to a terrestrial receiver, but only 500 MHz in uplink, i.e. transmitting from a terrestrial transmitter to a satellite. In contrast hereto in Ka band satellite communications a bandwidth of 2 GHz both in downlink and uplink is most common. More specifically it is common for civil applications to use for downlink a frequency band between 18 and 20 GHz and for uplink a frequency band between 28 and 30 GHz. Military applications use for downlink a frequency band between 19 and 21 GHz and for uplink a frequency band between 29 and 31 GHz. Thus in Ka band uplink and downlink frequency band are 8 GHz apart from each other. Known radiating elements with relatively short septum polarizer would not allow using the same antenna arrangement for two different frequency bands, when the offset between the two frequency bands is more far apart than the fractional bandwidth of the radiating elements. Unfortunately the few prior art documents that claim to provide a broadband bandwidth with a single antenna arrangement do not disclose the length of the stepped septum. However, from the drawings of those few documents it is apparent that the axial length of those septums, often with five or more steps, are three times or more the wavelength of the lower frequency band.

As a consequence where weight and/or size is an issue a first antenna array is used for receiving microwave signals and a second antenna array is needed for transmitting microwave signals. Sometimes this first antenna array with radiating elements with a single polarization is interlaced with a second antenna array with radiating elements of orthogonal polarization, providing physically a single arrangement. However, this does not allow for switching polarizations, i.e. to switch for example in uplink from Left Hand circular polarization, LHCP, to Right Hand circular polarization, RHCP, and vice versa. It is therefore an object of this invention to enable a radiating element, respectively an antenna arrangement comprising a plurality of radiating elements to be shared by microwave signals in different frequency bands and for different circular polarizations.

### SUMMARY OF THE INVENTION

This object is achieved in that a waveguide a radiating element for receiving and transmitting microwave signals in a lower frequency band (RX) and a higher frequency band (TX), the radiating element comprising a septum polarizer extending in axial direction of the radiating element dividing the radiating element in a first section, fed by a first feeding waveguide, for transmitting and/or receiving a frequency band in a first polarization and a second section, fed by a second feeding waveguide, for transmitting and/or receiving a frequency band in a second polarization that is orthogonal to the first polarization. The first and the second feeding waveguides as a function of their cross-section have a fundamental mode cut-off frequency and a higher mode cut-off frequency. According to the invention the length (L_{B}) of the septum (4) is as short as that a stop frequency band is present which does not allow for continuous transmission/reception between the fundamental mode cut-off frequency (f_{C1}) and the higher mode cut-off frequency (f_{C2}). According to the invention the fundamental mode cut-off frequency and the septum geometry are adapted such that the stop frequency band ends below the higher frequency band (TX).

Rather than striving to achieve an extreme broad frequency bandwidth between a lower cut-off frequency and an upper cut-off frequency, the invention teaches to allow for at least one stop frequency band between the lower cut-off frequency and the upper cut-off frequency of the beam forming waveguide. At least one frequency band is placed above the stop band. By choosing the cut-off-frequency of the radiating element different to the lower cut-off frequency of the radiating element, the stop band can be moved relative to the lower and upper cut-off frequency of the beam forming waveguide, so that first frequency band and the second frequency band can be fully used. In contrast to prior art where cut-off frequency of the beam forming waveguide and the cut-off frequency of a radiating horn are both chosen close to the desired frequency band in order to minimize the size of the waveguide distribution and the size of the radiating elements the invention teaches to still keep the size of the beam forming network to a minimum but allow for an increased diameter of the radiating element in order to shift the frequency stop band by selecting an appropriate radiating element diameter and septum length.

FIG. 9a, 9b, 9c show the performance diagrams of a circular radiating element with a diameter aₒ of 14.2 mm. With a septum length of 25 mm for the triangular part of the septum this radiating element has been optimized for the second frequency band, which in this case starts for the target parameters as defined later in this document at approximately 18.9 GHz. With a diameter aₒ=14.2 mm the cut-off frequency of this radiating element has been set to 12.38 GHz for the dominant mode. With the smooth septum the second frequency band stretches from 18.8 GHz to 30.8 GHz, which is a sensational fractional bandwidth of 48% and covers practically the full Ka band, which extends from 18 GHz to 31 GHz. This extreme wide bandwidth allows for example to use this radiating element for receiving microwave signals between 19 GHz and 21 GHz, in a receive band RX, and emitting radio signals between 29 GHz and 31 GHz, in a transmit band TX, whereby receive band RX and transmit band TX are within a continuous frequency band. By varying the diameter aₒ of the circular radiating element this continuous frequency band can also be shifted downwards, so that it is possible to cover the civil applications with a downlink frequency band of 18 GHz and 20 GHz an uplink a frequency band between 28 GHz and 30 GHz.

It should be well noted that in prior art the radiating elements had been optimized to send or receive in a frequency band that is close to the cut-off frequency of the dominant mode. This frequency band will be referred to in the following as the dominant mode frequency band. In contrast hereto the invention teaches to use radiating elements to receive and transmit at least one of the transmit frequency band TX or receive frequency band RX in a frequency band that is higher than the dominant mode frequency band. This frequency band above the higher mode frequency band is referred to in the following as the higher mode frequency band f_{HH}. The dominant mode frequency band f_{DD} and the higher mode frequency band f_{HH} are separated by a frequency band that will be referred to as a stop band f_{XX}. FIG. 9b shows that by the optimization of the higher mode frequency band f_{HH}, the dominant mode frequency band basically has been reduced to a centre frequency f_{C1} of the dominant frequency band at 15.0 GHz. Thus the stop band f_{XX} stretches in FIG. 8b from 15.0 GHz to 18.8 GHz.

It is not trivial to explain the phenomena of multiple operative frequency bands and it depends on the cross section of the radiating element. The multiple operative frequency bands are caused by an interaction of higher-order modes in the polarizer. For a circular radiating element, divided into two half-circular waveguides by the rectangular area of the septum the frequency band with the lowest frequencies is obviously connected with a TE₁₀ fundamental mode in the half-circular waveguides and the two degenerate fundamental TE₁₁ modes in the circular waveguides, the other frequency bands are also connected to higher order modes supported by the waveguide of the radiating elements, such as the TM₀₁ and the two degenerate TE₂₁ modes. So far the triangular septum, i.e. a smooth edge, without steps is the only way known to cause this effect. For square shaped radiating elements in contrast to circular radiating elements, the TE₁₀ fundamental mode of the two rectangular waveguides (resulting from the square waveguide split by the septum) are coupled in the first band to the two degenerate fundamental modes of the square waveguide TE₁₀ and TE₀₁ modes. In the second band also two other higher-order modes, in propagation in the second band, contribute to the final performance: the degenerate modes TE₁₁ and TM₁₁.

The lower boundary of the higher mode band f_{HH} depends on the target parameters S₁₁, S₂₁, XPD. It seems to be impossible to give a formula that calculates the lower frequency boundary for a triple of given target parameters S₁₁, S₂₁, XPD. However, it became evident that in the research of the inventor for such a formula, that the center frequency of the stop band is a function of the width of the cross section of the waveguides which connect the radiating element with a transceiver.

FIG. 14a shows the S₁₁ parameter over a frequency range from 18 GHz to 32 GHz as a function of the diameter aₒ of a circular radiating element and a fixed value of 15.0 mm for the length L_{B} of the triangular part of the polarizer septum. FIG. 14b shows the similar diagram for S₂₁ and FIG. 14c the similar diagram for the XPD. Whilst the curves demonstrate that there seems to be no general correlation between the target parameters, it is obvious that the local maxima for a given diameter aₒ for the target parameters S₁₁, S₂₁, XPD coincide. For a diameter aₒ=10.0 mm, the first center frequency f_{X1} of the first stop band is for all three target parameters at approximately 24.5 GHz; for a diameter aₒ=10.5 mm, the second center frequency f_{X2} of the second stop band is for all three target parameters at approximately 23.4 GHz; for a diameter aₒ=11.0 mm, the third center frequency f_{X3} of the third stop band is for all three target parameters at approximately 22.3 GHz; for a diameter aₒ=11.5 mm, the fourth center frequency f_{X4} of the fourth stop band is for all three target parameters at approximately 21.4 GHz; and for a diameter aₒ=12.0 mm, the fifth center frequency f_{X5} of the fifth stop band is for all three target parameters at approximately 20.5 GHz.

By calculating the ratio between these center frequencies f_{X1}, f_{X2}, f_{X3}, f_{X4}, f_{X5} of the stop bands and their cut-off frequencies for each diameter aₒ it transpires that this ratio is a quasi-constant with the value of 1.390 and a standard deviation of 0.001576 (For the actual calculation the values have been taken into consideration with a higher resolution than the diagrams are able to show). Repeating this exercise for square radiating elements gives a ratio of 1.35 at a standard deviation of 0.013. These ratios are valid at least for radiating elements with a close to optimal septum length L_{B}. As a rule of thumb we may deduct from the diagrams that the lower frequency of the higher mode frequency band starts at a frequency which is at least 10% higher than the centre frequency of the stop band. However, the diagrams of FIGS. 14a and 14b were used only for the purpose of demonstrating the relationship between cut-off frequency and centre frequency of the stop band and were not optimized for the S₁₁, S₂₂, or XPD parameters.

The ordinal numeral “first” in “first frequency band” and “second” in “second frequency band” do not indicate an order of the frequency bands in the sense that the second band is located at higher frequencies than the first band. When two transceivers communicate with each other in duplex mode, the same band is used in one direction as a transmit band TX and in the opposite direction as the receive band RX. Especially in satellite communications, the lower frequency band of two frequency bands is used for downlink communication, as the lower frequency bands suffers less from attenuations of the atmosphere. This helps to reduce the power consumption in the satellite. If the satellite had to transmit in the frequency band with the higher frequency, the transmitter would need to transmit at a higher power level in order to achieve the same reception level in the terrestrial receiver. Conversely, the power of the transmitter of a terrestrial transmitter usually is more easily available as for a satellite in space.

In the following some diagrams are presented to visualize the presence of a higher mode frequency band f_{HH} as a function of the cross section of the radiating elements, (round or square), the frequency of the dominant mode frequency band f_{DD} and the effect of a variation of some parameters. Apart from FIG. 13a-13c all diagrams are based on circular radiating elements, as shown in FIGS. 2, 3 and 4. Applying the above defined preconditions to a circular radiating element according to the invention with a straight edge, the performance of which has been optimised, as will be explained in details later, to receive and/or transmit in the Ku band, the lower frequency boundary of the dominant mode frequency band f_{DD} is limited by the S₂₁ parameter to 10.3 GHz, as can be seen in FIG. 12a-FIG. 12c. The upper frequency of the dominant mode frequency band f_{DD} is limited by the cross-polarization to 12.6 GHZ, although the return loss S₁₁ and Isolation S₂₁ are acceptable up to 12.8 GHz. Applying all limitations as defined above cumulatively results in a first frequency band RX between 10.3 GHz and 12.6 GHz, giving a band width of 2.3 GHz. The lower frequency of the second frequency band TX starts due the cross-polarization discrimination at 14.0 GHz, although the return loss S₁₁ and Isolation S₂₁ would be sufficient, i.e. better than −10 dB already above 13.2 GHz. Unfortunately, the diagrams end at a frequency of 16 GHz, where all three parameters S₁₁, S₂₁, XPD are better than the limits as defined above. Thus, the second frequency band spans at least from 14.0 GHz to 16 GHz and provides at least a bandwidth of 2 GHz. It is evident, that the optimum design depends on the target criteria that have been defined. Changing the target criteria, for example targeting at a better return loss S₁₁ or a better isolation S₂₁, but allowing a lower cross polarization XPD and optimising the dimensions with respect to the new target parameters, may not only result in different frequency bands, but also in different curves.

Dual polarization and simultaneously transmit and receive on both bands for both subsections allows for a variety of combinations. For example, transmitting and/or receiving microwave signals of the first frequency band in the first subsection and emitting and/or transmitting microwave signals of the second frequency band in the second subsection when the microwave signals have opposite circular polarization. Alternatively or in addition emitting and/or receiving microwave signals of the first and second bands in the first section, associated to one given circular polarization, and emitting and/or receiving microwave signals of the first and second bands in the second section, associated to the orthogonal circular polarization.

In one aspect of the invention the septum geometry adaptation comprises at least one adaption of a shape of the septum, the length of the septum, size and location of an opening in the septum.

In another aspect of the invention the length of the septum (L_{B}) is less or equal to two times the wavelength (λ_{C1}) of the fundamental mode cut-off frequency (f_{C1}).

In another aspect of the invention the septum polarizer comprises a essentially triangular area (42) and wherein the longest edge of the essentially triangular area (42) is a segment of one of a linear, sinusoidal, polynomial, logarithmic or exponential graph.

The septum polarizer comprises a tapered and smooth septum edge, without any step regions. The septum edge faces the opening and culminates in a septum tip. A polarizer septum in general enables a radiating element to emit or receive microwave signals of a first frequency band in the first subsection in a first circular polarization and to emit or receive microwave signals of frequency band in the second subsection with a circular polarization that is opposite to the first subsection. The tapered and smooth polarizer septum enables the radiating element to operate at a frequency band that in ideal configurations is between 100% up to 200%, or even beyond 200% of the cut-off frequency, as will be explored later with respect to FIGS. 9a, 9b, 9c.

Basically, the septum has the form of a pentagon with two parallel sides, a septum base, which is perpendicular to both parallel sides and a tapered smooth edge, without steps. The parallel sides are also parallel to the longitudinal axis of the radiating elements. A first parallel side of the two parallel sides intersects with a first inner wall section of the radiating element and a second parallel side of the two parallel sides intersects with a second inner wall section of the radiating element, which, with respect to the longitudinal axis of the radiating element is opposite to the first inner wall section. As the two parallel sides are different in length the pentagon in fact is composed of a rectangular area, which is the area closer to the bottom of the radiating element, and a triangular area, which is the area closer to the opening of the radiating element.

The rectangular area of the septum has the function of a waveguide section and the triangular section of the septum has the function of a polarizer. The separation line between the rectangular area and the triangular area is parallel to the septum base and is termed in the following “polarizer base”. The edge connects the vertex, where the shorter of the two parallel sides intersects with the polarizer base, with the tip, i.e. an end of the longer of the two parallel sides, which is opposite to the septum base. Triangular within this document is not restricted to a triangle in Euclidean trigonometry. It does not mean that the edge is restricted to a straight line, although a straight line works perfectly. In contrast, it has been observed that as long as the edge of the septum between the vertex and the tip, excluding the vertex and the tip, is a continuous curve without inflection point or saddle point, any form of the polarizer septum with an area substantially similar to the area of a triangle with a straight edge, will produce the desired effect. Or in other words, this is equivalent to so-called C1 functions, which by definition consist of all differentiable functions whose derivative is continuous. Again, this excludes the vertex and the tip as here the septum intersects the inner wall of the radiating element and discontinuities are allowed.

As another embodiment, shown in FIGS. 11a, 11b, and 11c the above defined preconditions are applied to a radiating element adapted for the Ka band. In this embodiment the triangular septum of the radiating element has a length L_{B}=15 mm and a diameter aₒ=11 mm. The feeding waveguide has a cut-off frequency of 16.5 GHz.

At this stage, same as above, only the effect by a plain tapered, and smooth septum polarizer is shown, and no other improvements to the septum are included. In this case the dominant mode frequency f_{DD} band starts below 18 GHz as both return loss S₁₁ and isolation S₂₁ are better than −10 dB at 18 GHz and cross polarization XPD is better than −15 dB at 18 GHz. The dominant mode frequency band f_{DD} ends at approximately 21.8 GHz as at this frequency the cross polarization XPD falls below −15 dB, although return loss S₁₁ and isolation S₂₁ are sufficient up to 22.0 GHz. Similarly, the higher mode frequency band f_{HH} starts at 25.1 GHz and ends at 31.8 GHz. Thus results in a stop band f_{XX} stretching from 21.8 GHz to 25.1 GHz. In this configuration of the radiating element a first frequency band RX with a bandwidth of 2.0 GHz can be placed in the dominant mode frequency band f_{DD} at 18.0 GHz and a second frequency band TX of 2.0 GHz bandwidth can be placed in the higher mode frequency band f_{HH} at 28.0 GHz. This covers the usual civil applications. With the same configuration of the radiating element the first frequency band RX can be placed in the dominant mode frequency band f_{DD} at 19.0 GHz and the second frequency band TX can be placed in the higher mode frequency band f_{HH} at 29.0 GHz in order to cover the usual military applications. Similar to previous embodiment the first frequency band RX was chosen as the receive band and the second frequency band TX was chosen as the transmit band, as it makes sense for a terrestrial or aerial based transceiver. As pointed out, for example if used in a satellite, the frequency bands may be used in the opposite order, or for any other application both frequency bands may be used for transmitting or both frequency bands may be used for receiving.

By changing the dimensions of the waveguide the cut-off frequency is shifted upwards or downwards. Consequently the dominant mode frequency band f_{DD}, stop band f_{XX}, and the higher mode frequency band f_{HH} can be shifted towards higher frequencies or lower frequencies, These two examples of FIG. 11a-11c and FIG. 12a-12c illustrate that for circular radiating elements operating in two different dominant frequency bands, the invention scales with the microwave frequencies. The person skilled in the art therefore will appreciate that the invention is not restricted to these bands, but may be also used with other bands.

In another aspect of the invention the radiating element has a square cross section. FIGS. 13a, 13b, 13c show the performance of an optimized square radiating element. The width a, of the square radiating element is 9 mm and the length L_{B} of the triangular section of the septum polarizer is 16 mm. Taking into account the same target parameters S₁₁=10 dB, S₂₁=10 dB and XPD=15 dB the square radiating element would allow for a receive band RX in the dominant mode frequency band f_{DD} from below 18 GHz to 22.2 GHz and for a transmit band TX in the higher mode frequency band f_{HH} between 23.5 GHz and above 32.0 GHz. Thus, in comparison to the circular radiating element the dominant mode frequency band f_{DD} is extended from 21.7 GHz to 22.2 GHz whereas the higher mode frequency band f_{HH} starts for both, an optimized radiating element with a circular cross section and a radiating element with a square cross section, at the same frequency of 23.5 GHz.

The advantage of a radiating element with a circular cross section however is that it is easier to manufacture as it can by produced on a lathe. As long as the target parameters S₁₁, S₂₁ and XPD can be achieved in the target frequency bands, which for the Ka band are 18-21 GHz for RX and 28-31 GHz for TX, and no other parameters are of relevance, there is no need to go for a radiating element with a square cross section. However, as it has been demonstrated, the person skilled in the art by varying the width a, of a square radiating element or the diameter aₒ of a circular radiating element, the length L_{B} of the triangular section of the tapered polarizer septum, some options to find the best performing radiating element for his intended purpose.

As has been demonstrated the invention can be used with radiating elements with a circular cross section and radiating elements with a square cross section. The invention probably could be used also with other cross sections, but such radiating elements have no practical use as they would be too costly to produce.

Unfortunately, the three parameters to be optimized, the input return loss S₁₁ the isolation S₂₁ and the cross-polarization discrimination XPD are affected differently by a variation of the polarization septum length L_{B}, so that there is no single best solution. Therefore a person skilled in the art would have to run some tests or simulations in order to find the optimum septum length L_{B} that serves his intended application most. FIG. 15a shows the situation for a circular radiating element suitable for the Ka band, when the polarization septum length L_{B} is incremented in steps of 1 mm from 10 mm to 15 mm. Suitable for the Ka band means that the diameter aₒ of a circular radiating element has been chosen to 11 mm to allow for a fundamental mode propagation in the radiating element above the cut-off frequency of 16.5 GHz. Obviously, the waveguides which connect the circular radiating element with a transceiver must have dimensions to allow for at least the same cut-off frequency as the cut-off frequency of the radiating element.

It is apparent from FIG. 15a that with an increase of the polarization septum length L_{B} from 10 mm to 15 mm return loss S₁₁ in the lower frequency band steadily improves and a local minimum is shifted from approximately 22 GHz to 18.6 GHz. FIG. 15b shows the situation when the polarization septum length L_{B} is further incremented from 15 mm to 20 mm. As it is apparent, the S₁₁ parameter degrades in the lower frequency range, and the local minimum has moved below 18 GHz. With respect to the S₁₁ target value of −10 dB, any polarization septum length L_{B} from 10 mm to 14 mm would allow a bandwidth from 18 GHz to at least 32 GHz. The bandwidth for polarization septum length L_{B} of 15 mm in contrast limits the dominant mode frequency band f_{DD} from below 18 GHz to 22 GHz and allows for a higher mode frequency band f_{HH} to start at 22.8 GHz. There are also variations of the S₁₁ parameter in the higher frequency regions. But as from 22.8 GHz upwards, the S₁₁ parameter stays below the target value of −10 dB, the S₁₁ performance above 22.8 GHz is not affected by of the polarization septum length L_{B}, at least for a variation of the polarization septum length L_{B} between 10 mm and 20 mm.

Turning now to the S₂₁ parameter as shown in FIGS. 15c and 15d the maximum bandwidth for the S₂₁ parameter is achieved with any polarization septum length L_{B} between 11 mm and 14 mm, which allows for a bandwidth from 18 GHz to above 32 GHz. A polarization septum length L_{B} of 15 mm for example introduces a stop band between 22.2 GHz and 22.9 GHz.

As we can see from FIGS. 15e and 15f the limiting factor for the bandwidth is the cross-polarization discrimination XPD. The target value for XPD shifts the dominant mode frequency band f_{DD} with increasing polarization septum length L_{B} to lower frequencies and allows for a maximum bandwidth in the dominant mode frequency band f_{DD} at a polarization septum length L_{B} of 15 mm from 18 GHz to 21.9 GHz. The higher mode frequency band f_{HH} starts where the XPD target value of better than −15 dB is met for a polarization septum length L_{B} of 15 mm at around 25 GHz and stretches to 31.3 GHz.

Combining all three results such that all three target conditions for input return loss S₁₁, isolation S₂₁, and the cross-polarization discrimination parameter XPD are met, finally leads to an optimized polarization septum length L_{B} of 15 mm which allows for a dominant mode frequency band f_{DD} from 18.0 GHz to 22.0 GHz and a higher mode frequency band f_{HH} from 25 GHz to 31.3 GHz. Thus the available bandwidth in the dominant mode frequency band f_{DD} is 4.0 GHz. Similarly, the available bandwidth in the higher mode frequency band f_{HH} is 6.3 GHz, whereas the stop band f_{XX}, which separates the dominant mode frequency band f_{DD} and the higher mode frequency band f_{HH} is 3.0 GHz.

The person skilled in the art will readily appreciate that the frequency bands are defined by the target values for input return loss S₁₁, isolation S₂₁, and the cross-polarization discrimination XPD. If a transceiver design is used, that would need for its performance one or the other parameter to meet a higher threshold, than the usable frequency bands may be narrower. On the other hand, if a specific transceiver design allows for one or the other parameter to be relaxed, this may allow for wider frequency bands.

FIGS. 16a, 16b, 16c show the effect of moving an opening 5a from the basis of the triangular part towards the tip of the triangular part on a radiating element with a polarization septum length L_{B} of 15 mm. In this example the opening has a diameter of 2.5 mm and its center is placed 2.5 mm from the closest inner wall of the radiating element. The stop band f_{XX} moves with increasing distance A_{X} about 5% towards lower frequencies. Apart from this, all target parameters are affected very little in the dominant mode frequency band. The more prominent effect of moving the opening towards the tip can be seen in the higher mode frequency band f_{HH}, and especially in the higher frequencies of the higher mode frequency band f_{HH}. The S₁₁ parameter as shown in FIG. 16a would end the higher mode frequency band f_{HH} at 31.6 GHz. Placing the opening at A_{X}=7 mm enables the higher mode frequency band f_{HH} to be extended beyond 32.0 GHz. Placing the opening at A_{X}=7 mm has a similar effects to the S₂₁ parameter. The biggest effect again is on the XPD, which extends the upper frequency boundary of the higher mode frequency band f_{HH} from 30.0 GHz to 31.0 GHz. In summary, taking all target parameters in account, a well-chosen value for Aₓ extends the higher mode frequency band f_{HH} from 22.3 GHZ to 30.0 GHz to 22.2 GHz to 31.0 GHz.

FIG. 17a-17c demonstrate the effect of the diameter A_{D} of the opening on the target parameters S₁₁, S₂₁ and XPD. The results shown in FIG. 17a-16c are for a circular horn with a triangular shaped septum with a septum length of L_{B}=15 mm. The centre of the opening is 7 mm from the basis of the triangular section of the septum and 2.5 mm from the closest wall of the circular radiating element. As can be seen in FIGS. 17a and 17b the diameter A_{D} of the opening does not deteriorate the S₁₁ and S₂₁ with respect to the dominant mode frequency band f_{DD}. In the higher frequencies of the higher mode frequency band an increasing opening reduces the S₁₁ and S₂₁ parameter, but they still remain within the target threshold. FIG. 17c finally shows that an increasing diameter A_{D} of the opening however improves the XPD. In particular we have a considerable improvement in the ranges 18-20 GHz, 24-26 GHz and 28-30 GHz. An increasing opening also shifts the stop band f_{XX} towards lower frequencies by up to 1.4 GHz compared to an opening of 0.5 mm, which is almost the same as having no opening.

FIG. 18a-FIG. 18d compare the effect of a triangular septum with no opening to a triangular septum of the same size with an opening. The polarization septum length L_{B} for both septums is 15 mm. FIG. 18a-FIG. 18d the opening 5c has an optimized shape, although with an opening 5b almost the same effect is achieved. FIG. 18c shows that without a septum the target parameters are met for a dominant frequency band f_{DD} from below 16.0 GHz up to 21.6 GHz. With the opening, the upper end of the dominant frequency band fA_{DD} is pushed down to 21.3 GHz. More importantly, the size of stop band fₓₓ for a triangular septum without opening is reduced from 3.2 GHz to 2.0.GHz for a stop band fA_{XX} with a triangular septum with an optimized opening. This allows for having a first frequency band and a second frequency band only separated by a gap less than 10%.

The opening splits however the usable higher mode frequency band into a first higher mode frequency band fA_{H1} and a second higher mode frequency band fA_{H2}. As the purpose of the opening in this case was to reduce the size of the stop band f_{XX} this additional gap in the higher mode frequency band is for such applications with a smaller stop band f_{XX} of no concern. The additional higher mode frequency band can be useful in multi-purpose or multi-function systems where three operative bands are required. The introduction of the opening 5c further improves the performance in terms of S₁₁, S₂₁ and XPD when compared to the design without opening.

In a further aspect of the invention the extension of the triangular area or quasi-triangular area between the basis of the triangular area or quasi-triangular area and the tip of the triangular area or quasi-triangular area preferably is in range of 0.5 times the cut-off frequency wavelength λ_{c} and two times the cut-off frequency wavelength λ_{c}. For example if a cut-off frequency f_{C} of 16.5 GHz has been chosen the cut-off frequency wavelength λ_{c} in free space is λ_{c}=c₀/f_{c}=18.2 mm. Consequently the preferred range for the length L_{B} of the triangular part of the septum is in the range of 9.1 mm to 18.2 mm.

In a further aspect of the invention, the triangular area or quasi-triangular area is a triangle whereby the angle between the side of the hypotenuse of the triangle and the waveguide element wall is in the range of 25 to 45 degrees, preferably 37 degrees.

In a further aspect of the invention, the longest edge of the quasi-triangular area is a segment of a sinusoidal, polynomial, logarithmic or exponential graph.

In a further aspect of the invention, the septum further comprises a rectangular area, which extends in radial direction of the axis of the radiating element from the bottom of the radiating element to the basis of the triangular area or quasi-triangular area.

In a further aspect of the invention, the septum polarizer comprises an opening creating a connection between the first subsection and the second subsection. With this opening the target parameters can be improved, respectively optimized for the higher frequency and the lower frequency band in question.

In a further aspect of the invention the center of the opening is placed in axial direction of the radiating element between one quarter and three quarters of the wavelength of the fundamental mode cut-off frequency.

A further aspect of the invention relates to microwave antenna array, comprising a plurality of the radiating elements according to the invention. In this microwave antenna array each first subsection of each of the plurality of radiating elements is in connection with a first element feed port and each second subsection of each of the plurality of radiating elements is in connection with a second element feed port. This microwave antenna array further comprises a first array feed port and a second array feed port, and a waveguide system with power dividers and/or power combiners connecting the first array feed port with the plurality of first element feed ports, such that each of the first element feed ports are in phase with each other and substantially at the same power level; and connecting the second array feed port with the plurality of second element feed ports such that each of the second element feed ports are in phase with each other and substantially at the same power level.

In another aspect of the invention a microwave antenna system comprises a plurality of radiating elements, wherein each first section of each of the plurality of radiating elements is in connection with a first element feed port and each second section of each of the plurality of radiating elements is in connection with a second element feed port. The microwave antenna system further comprises a first array feed port and a second array feed port, a first waveguide system with power dividers and/or power combiners connecting the first array feed port with the plurality of first element feed ports, such that each of the first element feed ports are in phase with each other and substantially at the same power level; and a second waveguide system with power dividers and/or power combiners connecting the second array feed port with the plurality of second element feed ports such that each of the second element feed ports are in phase with each other and substantially at the same power level.

In another aspect of the invention the microwave antenna system the H-plane of the waveguides of the first waveguide system and the second waveguide system is parallel to axis of the radiating elements. In this aspect of the invention the rectangular waveguides, the cross-section of which usually has a longer side and a shorter side is with its longer side orientated in the vertical direction of the antenna system. This allows to route longer waveguides within a given base area of the antenna system. These longer waveguide can be used to increase the number of radiating elements that are arranged in a block. As the waveguides are filed with air this also improves the weight of such a block.

In another aspect of the invention the microwave antenna system comprises a first plate, a second plate for being placed beneath the first plate, and a base plate for being placed beneath the second plate 82. The first plate has mounting holes in the top of the first plate for accommodating the radiating elements with their first element feed port and their second element feed port (921); first grooves in a bottom part of the first plate; first through holes connecting the first element feed ports with the first grooves; second through holes extending from the bottom of the first plate to the second element feed ports; having first grooves in a bottom part of the first plate; one end of each first grooves ending in one of the first through holes. The second plate has second grooves in a top part of the second plate, wherein the second grooves of the top part of the second plate correspond with the first grooves of a bottom part of the first plate when the bottom part of the first plate is placed on the top part of the second plate, forming with the first grooves of the first plate a first waveguide distribution layer; third through holes which correspond with the second through holes of the first plate when the bottom part of the first plate is placed on the top part of the second plate forming vertical passages through the first waveguide distribution layer for connecting a second waveguide distribution layer with the second element feed ports; third grooves in the bottom part of the second plate, one end of each third groove. The base plate has fourth grooves on a top part of the base plate, the fourth grooves corresponding with third grooves on the bottom part of a the second plate, when the bottom part of the second plate is placed on the top part of the base plate, forming the second waveguide distribution layer.

This modular concept allows for easy assembly of the antenna system as the tiles can be reused even in bigger arrangements.

In a further aspect of the invention, the plates of the microwave antenna system have connecting elements on the sides of the plates which enable the plates to mechanically be connected with each other in a horizontally direction and/or a vertically direction.

In another aspect of the invention the microwave antenna system the plurality of radiating elements are arranged such that their axis are orientated in parallel, forming a triangular lattice, with the advantage of strongly reducing the side lobe level in the azimuth plane in comparison with a square lattice with the same element spacing, thus increasing the maximum EIRP in compliance with ITU and ETSI radiation masks.

In another aspect of the invention the microwave antenna system the plurality of radiating elements are grouped in groups of three radiating elements, wherein the radiating elements of a group forms a triangle and that the first element feed ports of each group are individually fed by a first three-way power divider/combiner and that the second element feed ports of each group are individually fed by a second three-way power divider/combiner.

This arrangement also allows for a more dense arrangement of the waveguides of the beam forming network. This also for an array of four time six radiating elements to route one waveguide layer for a first polarization in primarily one physical layer and to route a second waveguide layer for an orthogonal polarization in primarily a second waveguide layer.

In another aspect of the invention the microwave antenna system a transition element between the first element feeding port or the second element feeding port, collectively named herein as the element feeding ports, and a first or second half-circular waveguide, respectively which is in communication with first and second sections of the radiating elements. In first transition section the cross section of the element feeding port is enlarged by a convexity for a first time, and in a last transition section the cross section of the half-circular waveguide is decreased by an incision, whereby the cross section area of the last transition section is larger than the cross section area of the first transition section. It has been found sufficient to have only a first and a last transition section, but if needed the person skilled in the art would know to implement any number of transition sections between the first and the last transition section.

In another aspect of the invention the microwave antenna system a 3-way power divider/combiner in form of a cross with a longer bar intersecting essentially perpendicular a shorter bar, with one input waveguide located in one bar end of the longer bar, a first output waveguide being located at the other end of the longer bar, a second output waveguide being located at one end of the shorter bar and a third output waveguide being located at the other end of the shorter bar, wherein the middle section of the cross widens from the one bar end towards the intersecting shorter bar.

In a further aspect of the invention, the power dividers/power combiners of microwave antenna system comprise structures for frequency filters.

In another aspect of the invention the microwave antenna system an electromechanical waveguide switch inserted between a first central input/output port, a high-pass filter, a low-pass filter and a second central input/output port, with a first waveguide segments and a second waveguide segment, the waveguide switch being adapted to actuate the first waveguide segment and the second waveguide segment in a first position and a second position. In the first position the first input/output port is connected by the first waveguide segment with the high-pass filter and the second central input/output port is connected by the second waveguide segment with the low-pass filter. In the second position the first waveguide segment connects the first central input/output port with the low-pass filter and the second waveguide segment connects the second input/output port with the high-pass filter.

In another aspect of the invention the microwave antenna system a top plate is arranged on top of the plurality of radiating elements; extending each horn of the radiating elements in axial direction. Optionally a gain-enhancing plate is arranged on top of the top plate, further extending the horns of the radiating elements in axial direction, wherein the apertures of the extended horns are overlapping.

In another aspect of the invention a microwave antenna array comprises a plurality of microwave antenna systems which are arranged on a single base plate. Fifth grooves on the bottom of the single base plate accommodate a first array waveguide system connecting the plurality of microwave antenna system with a first array port. Sixth grooves on the bottom of the single base plate accommodate a second array waveguide system connecting the plurality of microwave antenna systems with a second array port.

In a further aspect of the invention, frequency filters of the microwave antenna system connected to the first element feed ports are tuned to a transmitting frequency and frequency filters connected to the second feed ports are tuned to a receiving frequency.

Within the scope of this application it is expressly intended that the various aspects, embodiments, examples and alternatives set out in the preceding paragraphs, in the claims and/or in the following description and drawings, and in particular the individual features thereof, may be taken independently or in any combination. That is, all embodiments and/or features of any embodiment can be combined in any way and/or combination, unless such features are incompatible. The applicant reserves the right to change any originally filed claim or file any new claim accordingly, including the right to amend any originally filed claim to depend from and/or incorporate any feature of any other claim although not originally claimed in that matter.

### DRAWINGS

One or more embodiments of the present invention will now be described in detail, by way of example only, with reference to the accompanying drawings, in which:

FIG. 1 shows a satellite communication system

FIG. 2a shows a perspective view on the bottom side of radiating element

FIG. 2b shows a perspective view on the top side of a radiating element with a stepped septum

FIG. 2c shows a cross section view of a radiating element with two steps

FIG. 3 shows a cross section view of a radiating element with three steps

FIG. 4a shows a three-dimensional view of a radiating element

FIG. 4b shows a view of the radiating element from the backside

FIG. 4c shows a cross section of a radiating element along its longitudinal axis

FIG. 5a-5c shows diverse shapes of a triangular septum

FIG. 5d-5f shows examples of plots of class C1 functions.

FIG. 6a shows a perspective view on the top side of a square radiating element

FIG. 6b shows a perspective view on the bottom side of a square radiating element

FIG. 6c shows a cross section view of a square radiating element

FIG. 7a shows dimensions of a triangular septum with a hole

FIG. 7b shows an enhanced version of a hole in a septum

FIG. 7c shows a preferred version of hole in a septum

FIG. 8a-8c show performance diagrams for a circular radiating element with a two-stepped septum

FIG. 9a-9c show performance diagrams for another circular radiating element with a triangular septum

FIG. 10a-10c show performance diagrams for another circular radiating element with a three-stepped septum

FIG. 11a-11c show performance diagrams for a circular radiating element with a triangular septum for Ka band

FIG. 12a-12c show performance diagrams for a circular radiating element with a triangular septum for Ku band

FIG. 13a-13c show performance diagrams for a square radiating element with a triangular septum

FIG. 14a-14c show performance diagrams for a circular radiating element with a triangular septum and a variation of the diameter aₒ of the radiating element

FIG. 15a-15f show performance diagrams for a circular radiating element with a triangular septum and a variation of the septum length

FIG. 16a-16c show performance diagrams for a circular radiating element with a triangular septum and a variation of the axial position x of the hole in the septum of the radiating element

FIG. 17a-17c show performance diagrams for a circular radiating element with a triangular septum and a variation of the diameter A_{D} of the hole in the septum of the radiating element

FIG. 18a-18d show performance diagrams comparing a circular radiating element with a hole and without a hole in the triangular septum

FIG. 19 shows a three-dimensional view of single antenna module made of six times four radiating elements

FIG. 20 shows a cross section of the antenna module of FIG. 19

FIG. 21 shows the arrangement of the radiating elements in triplets

FIG. 22 shows a bottom view of the air volume of the antenna module of FIG. 19

FIG. 23a shows a first module waveguide layer of a beam forming network feeding first ports of the of the antenna module of FIG. 19

FIG. 23b shows a second module waveguide layer of a beam forming network feeding second ports of the of the antenna module of FIG. 19

FIG. 24 shows a connection of a half-circular waveguide to a rectangular waveguide without a transition

FIG. 25 shows a S₁₁ and a S₂₁ diagram for a connection of a half-circular waveguide to a rectangular waveguide without a transition as shown in FIG. 24

FIG. 26 shows a S₁₁ and a S₂₁ diagram for a connection of a half-circular waveguide to a rectangular waveguide with a transition as shown in FIG. 29

FIG. 27 shows the top view of the air volume inside the antenna module of FIG. 19

FIG. 28 shows the air volume of a feed waveguide for triplet of radiating elements

FIG. 29 shows the air volume of a transition from a rectangular waveguide to a half circular waveguide in a three dimensional view

FIG. 30 shows the air volume of a transition from a rectangular waveguide to a half circular waveguide in a two dimensional view

FIG. 31 shows a view of 3-way power combiner/divider

FIG. 32 shows the S₁₁ and S₂₁ performance of that 3-way power combiner/divider

FIG. 33a shows in a diagram the performance of a single circular radiating element as co-polar RX gain and cross-polar RX gain plotted over the off-axis angle

FIG. 33b shows in a diagram the performance of a single circular radiating element as co-polar TX gain and cross-polar TX gain plotted over the off-axis angle

FIG. 34a shows in a diagram the performance of a one times two module as co-polar RX gain and cross-polar RX gain plotted over the off-axis angle of the one times two module

FIG. 34b shows in a diagram the performance of a one times two module as co-polar TX gain and cross-polar TX gain plotted over the off-axis angle of the one times two module

FIG. 35 shows a base beam forming plate from a bottom view exposing RX and TX port

FIG. 36 shows in a diagram the antenna performance of a one times two module configuration

FIG. 37 shows a symbol for a module

FIG. 38a shows a schematic view of a 4×1 antenna array in a first configuration

FIG. 38b shows a schematic view of a 4×1 antenna array in a second configuration

FIG. 38c shows a schematic view of a 4×1 antenna array in a third configuration

FIG. 39a shows a first configuration with a circulator

FIG. 39b shows a second configuration with a circulator

FIG. 40 shows an arrangement allowing for simultaneous TX/RX in both polarizations

FIG. 41 shows an antenna array comprising two antenna modules of FIG. 19, in this case a one times two array, with a single top plate

FIG. 42 shows the antenna array of FIG. 41 with a gain-enhancing plate

FIG. 43a shows a three-dimensional view of the air volume of the antenna arrangement of FIG. 41 with an integrated band-pass filter for a receiving port and an integrated high-pass filter for a transmitting port

FIG. 43b shows a bottom view of the air volume inside the antenna arrangement of

FIG. 43a

FIG. 44 shows a top view of a three-dimensional view of an antenna arrangement composed of sixteen antenna modules in a four times four module configuration

FIG. 45 shows a bottom view of the air volume of the antenna arrangement of FIG. 45

FIG. 46 shows a bottom view of the air volume of the antenna arrangement of FIG. 45

FIG. 47 shows a perspective view with explosion of the different layers of the antenna arrangement of FIG. 45

FIG. 48a shows as a schematic diagram an arrangement of radiating elements in a triangular lattice

FIG. 48b shows as a schematic diagram an arrangement of radiating elements in a square lattice

FIG. 49 shows the antenna gain of the antenna arrangement of FIG. 45 over the azimuth

### DETAILED DESCRIPTION

Reference will now be made to the example embodiments illustrated in the drawings, and specific language will be used herein to describe the same. It will nevertheless be understood that no limitation of the scope of the disclosure is thereby intended. Alterations and further modifications of the features illustrated herein, and additional applications of the principles illustrated herein, which would occur to one skilled in the relevant art and having possession of this disclosure, are to be considered within the scope of the disclosure.

Within this document, the term “vertical” refers to directions parallel to the middle axis of a radiating element. The term “horizontal” indicates any plane that is perpendicular to the vertical direction. The relational terms “above” and “top” indicate objects which, especially in an assembled state of an antenna module or antenna array, are in a horizontal plane closer to the horn of a radiating element than a horizontal plane of an object the relational term refers to. Similarly, the term “below” and the term “bottom” indicate objects, which are in a horizontal plane, especially in an assembled state of an antenna module, or antenna array, more far away from the horn of a radiating element than a horizontal plane of an object the relational term refers to.

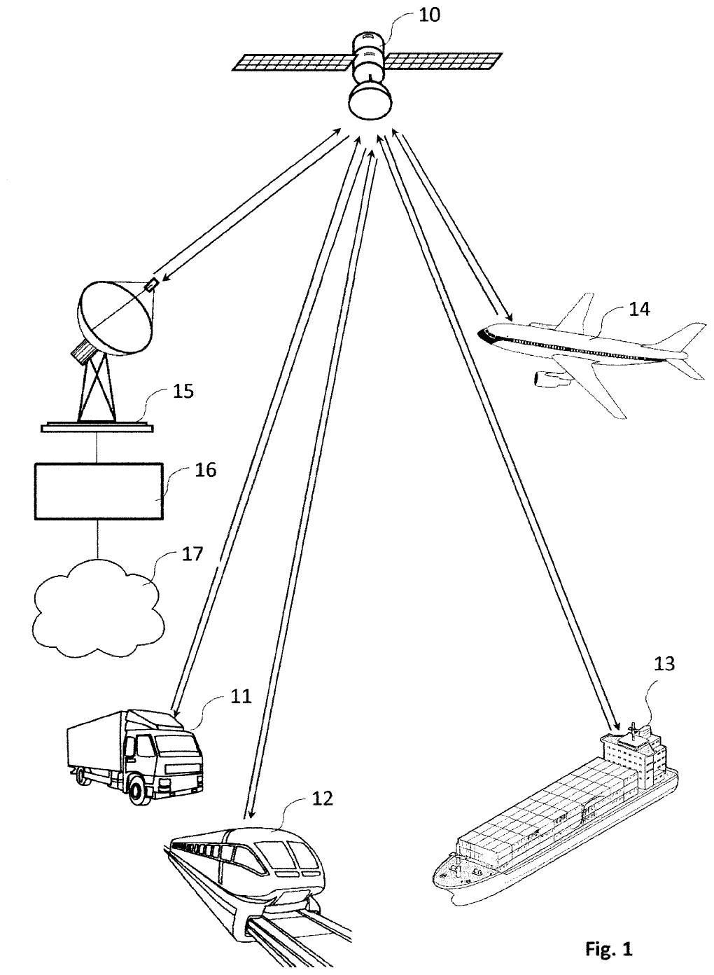

As an antenna according to the invention has less weight than a prior art antenna it is especially advantageous for the use in mobile user equipment. FIG. 1 shows a typical application of the invention in a satellite telecommunication system where a satellite 10 communicates with mobile user equipment installed in land based vehicles 11, including rail based vehicles 12, watercrafts 13 or aircrafts 14, for example. For this purpose the antenna may be mounted on a tracking system (not shown) covered by a radome (not shown). The satellite 10 relays information by microwave signals between the user equipment and usually at least one terrestrial station 15. The terrestrial station 15 is for example connected by a gateway 16 to a network 17; such as a land based telecommunication system including public switched telephone network, or data networks, such as the Internet. Antennas according to the invention may also be used in satellites 10 themselves, for example also for satellite to satellite communication. The invention is not restricted to satellite communication or mobile communication. It may be also used in fixed subscriber stations. It may be also used in any microwave signal applications, such as RADAR.

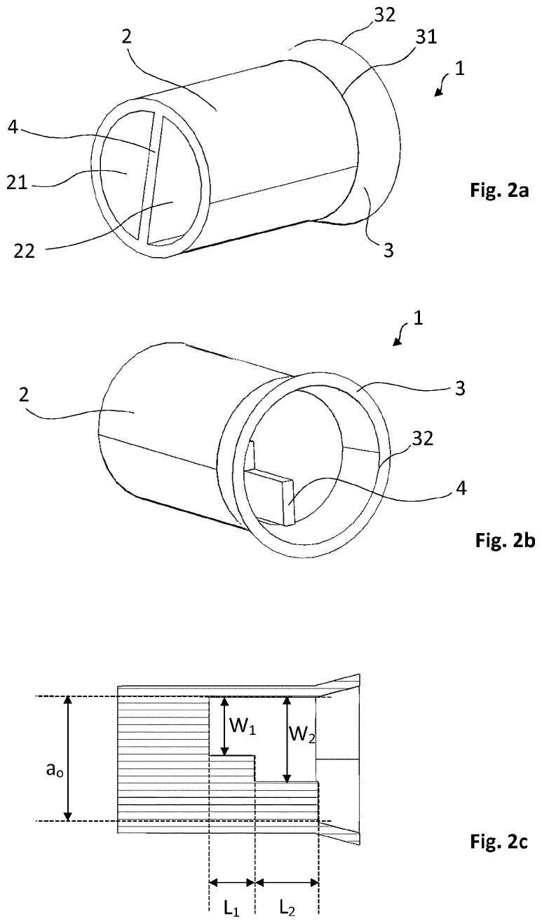

FIG. 2a shows in a three-dimensional view on the bottom part of a radiating element 1 according to the invention. The radiating element 1 comprises a radiating element waveguide 2 and in extension of that waveguide 2 a horn 3. The radiating element waveguide 2 and the horn 3 are hollow bodies for allowing the propagation of microwaves in the air volume enclosed by the radiating waveguide 2 and the horn 3. For this purpose the radiating element 1 is made either of electrical conductive material or at least its inner walls are covered with electrical conductive material. Whereas the radiating element waveguide 2 has a constant cross area along its middle axis, the cross section of the horn 3 flares from its smaller opening, termed in the following a throat 31, to its bigger opening, termed in the following a mouth 32.

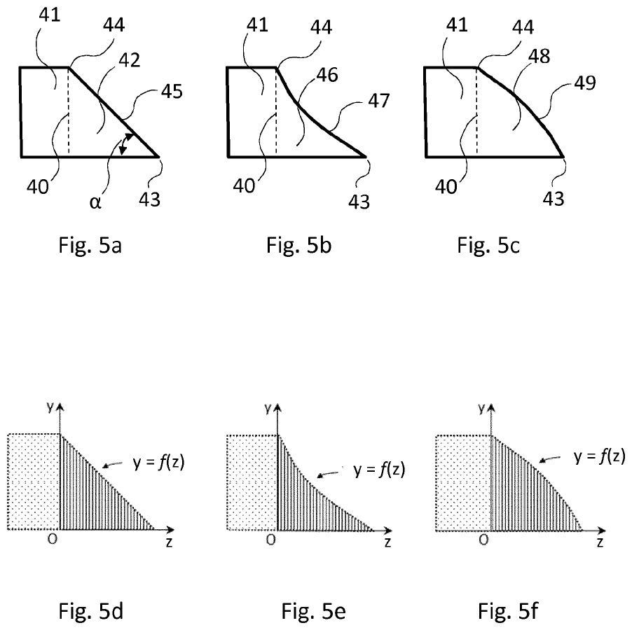

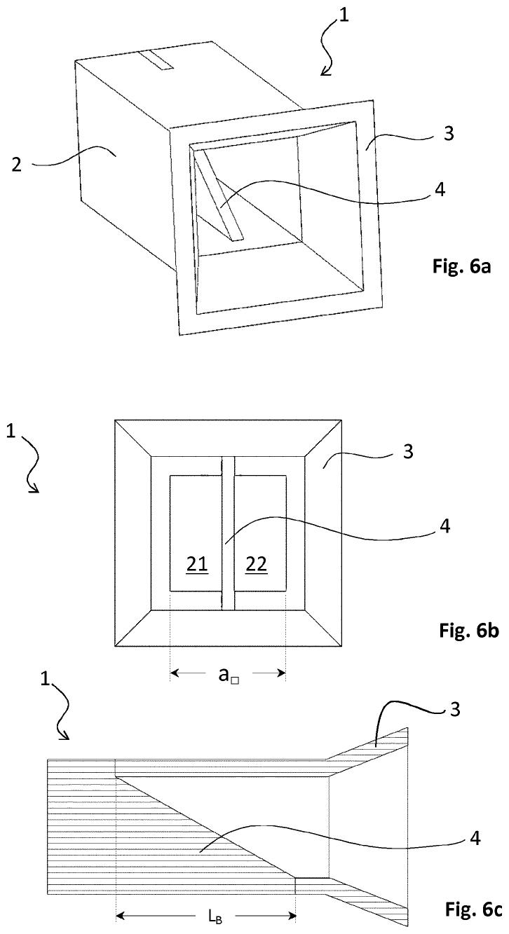

In this embodiment and all other embodiments apart from the embodiment shown in FIG. 6a, 6b, 6c, the radiating element waveguide 2 and the horn 3 are manufactured as rotational bodies so that the radiating element waveguide 2 in this embodiment is a cylindrical tube with a length L_{w} and an inner diameter aₒ. The horn 3 flares at a constant angle θ (shown in FIG. 5), so that it is a frusto-conical design with a length of L_{H}. The inner diameter of the throat 31 is the same as the inner diameter aₒ of the radiating element waveguide 2. If other manufacturing methods are used the radiating element waveguide 2 and the horn 3 may have any suitable cross section, for example a square cross section or a hexagonal cross section.

The radiating element 1 is designed as a dual orthogonal circularly polarized horn by placing a septum polarizer 4 into the waveguide 2. The septum polarizer or septum 4, as it is termed in short in the following, divides the inner space of the waveguide 2 in a first half-circular waveguide 21 and a second half-circular waveguide 22. The first half-circular waveguides 21 are associated with a first input/output port 911 and the second half-circular waveguide 22 are associated with a second input/output port 921. A septum 4 is an effective polarizer to generate circular polarizations from linear excitations of the waveguide and vice versa.

In this first embodiment a stepped septum with two steps is presented. As FIG. 2c shows in detail in a first step the septum 4 opens a first gap with a first gap width W₁ at a gap length of L₁. In a second step the septum 4 opens a second gap with a second gap width W₂ at a gap length of L₂. The following table shows a first and a second configuration of these dimensions.

| Parameter | Value |
|---|---|
| a_{○} | 12.0 mm |
| L₁ | 2.7 mm |
| L₂ | 5.2 mm |
| W₁ | 5.8 mm |
| W₂ | 9.3 mm |
| Performance | Fig. 50a-50b |

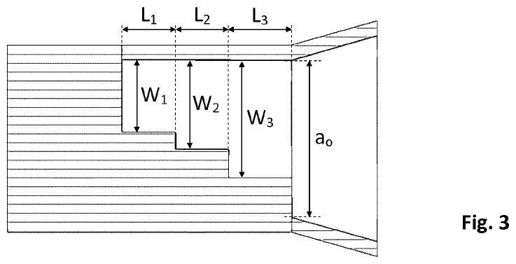

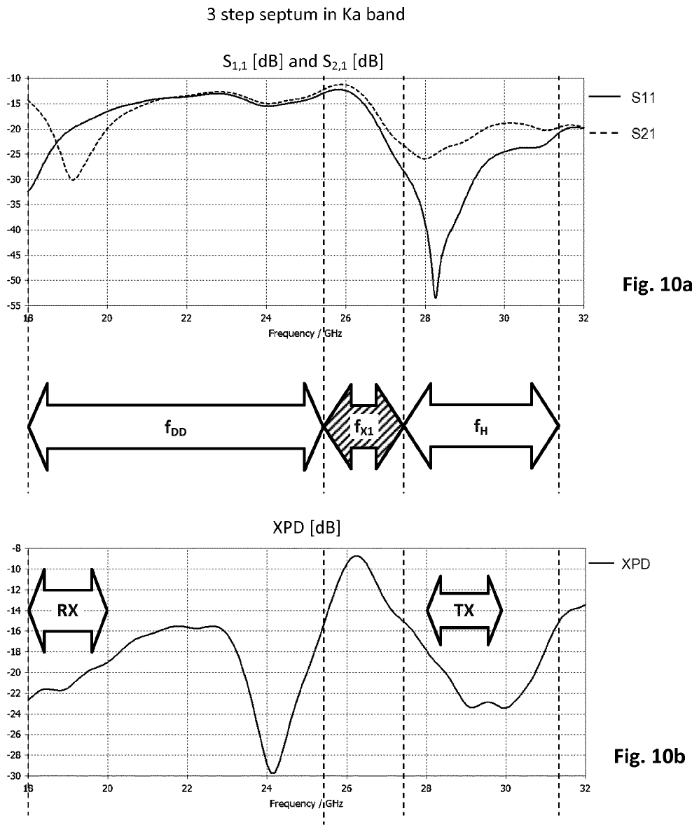

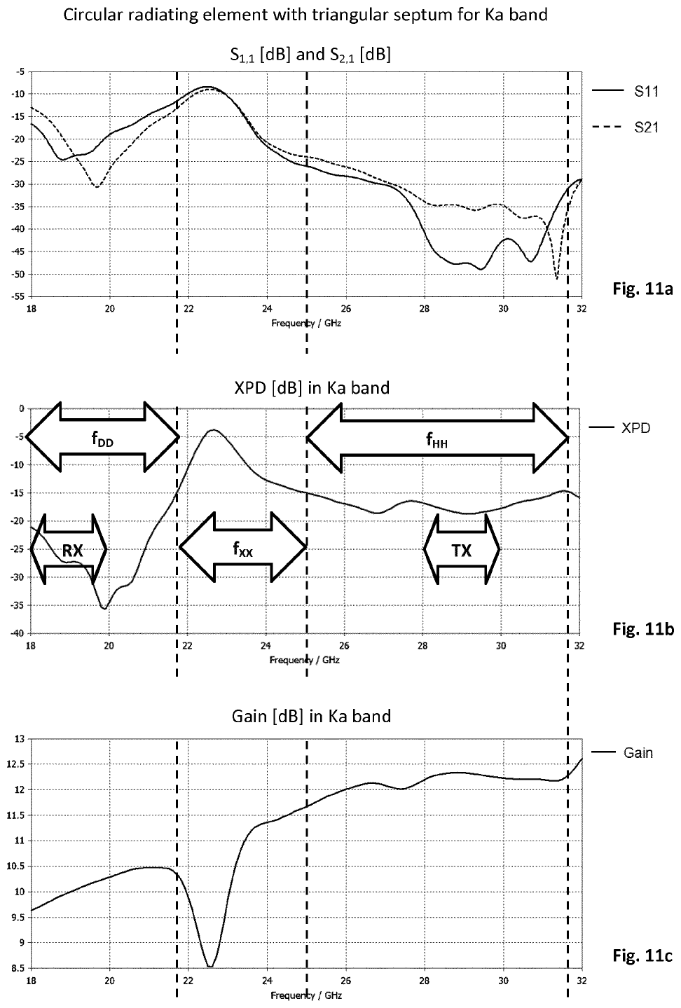

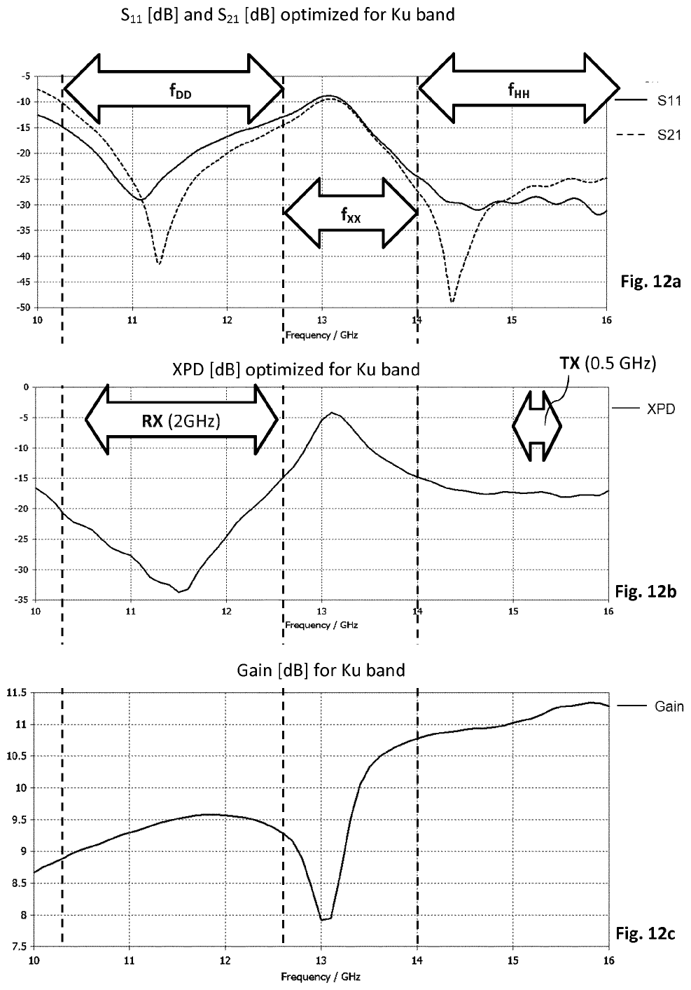

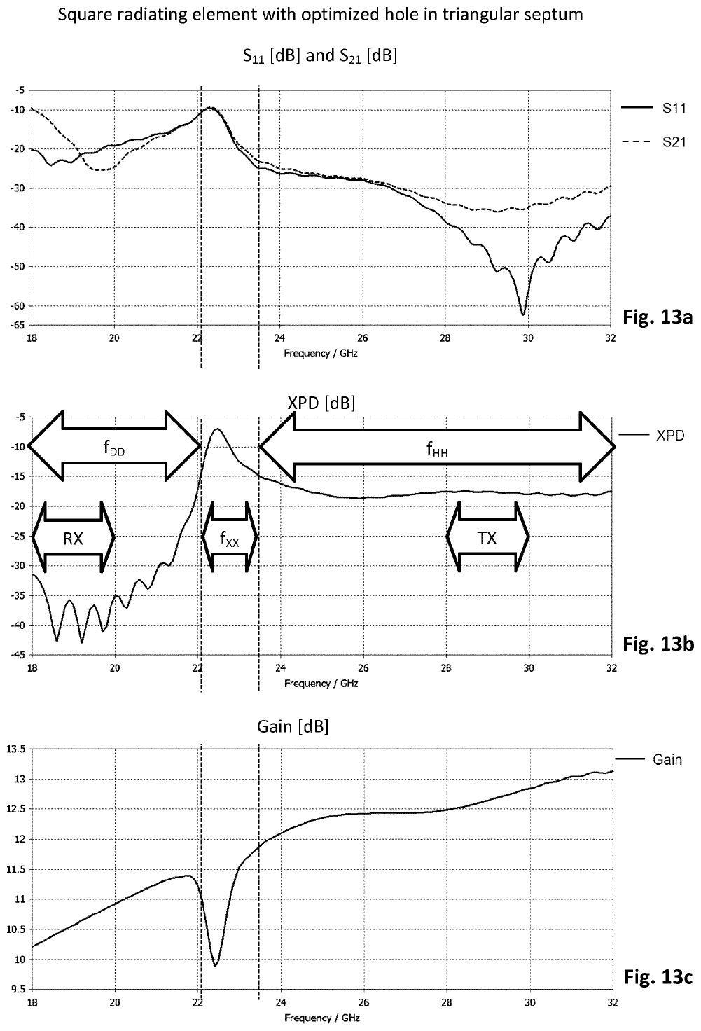

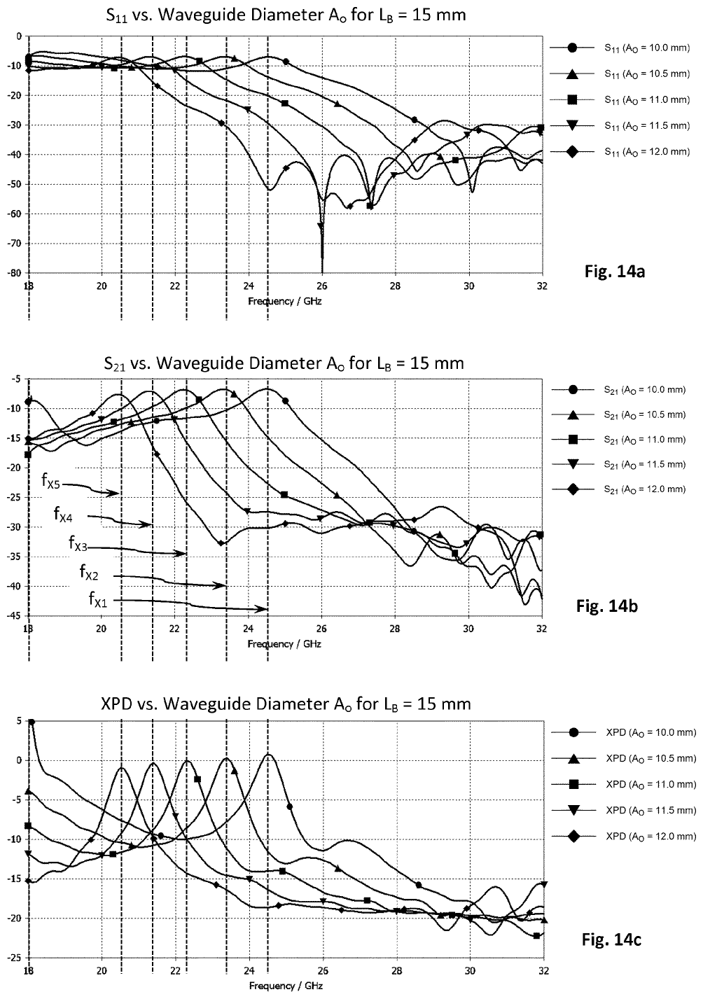

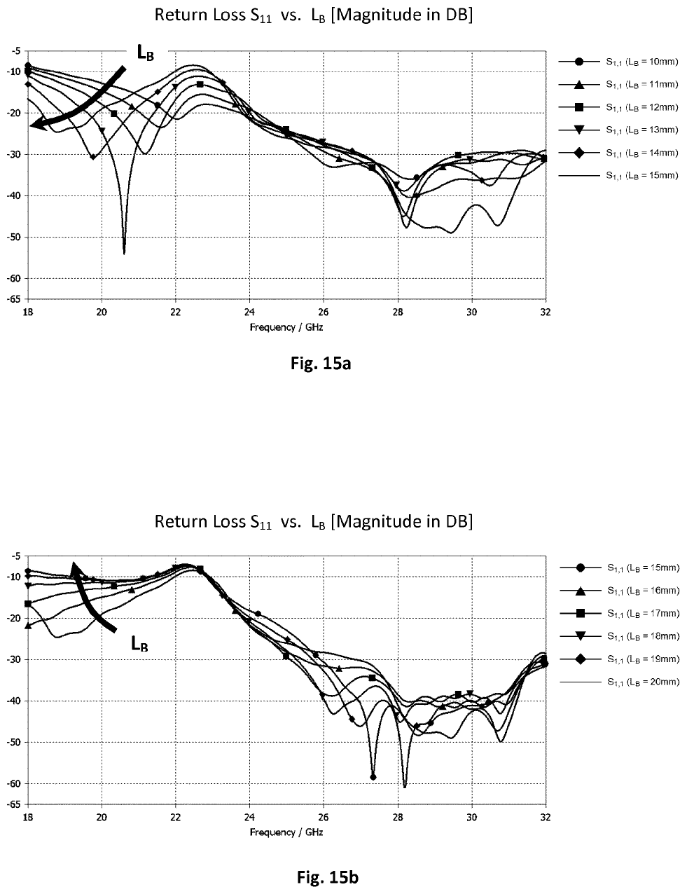

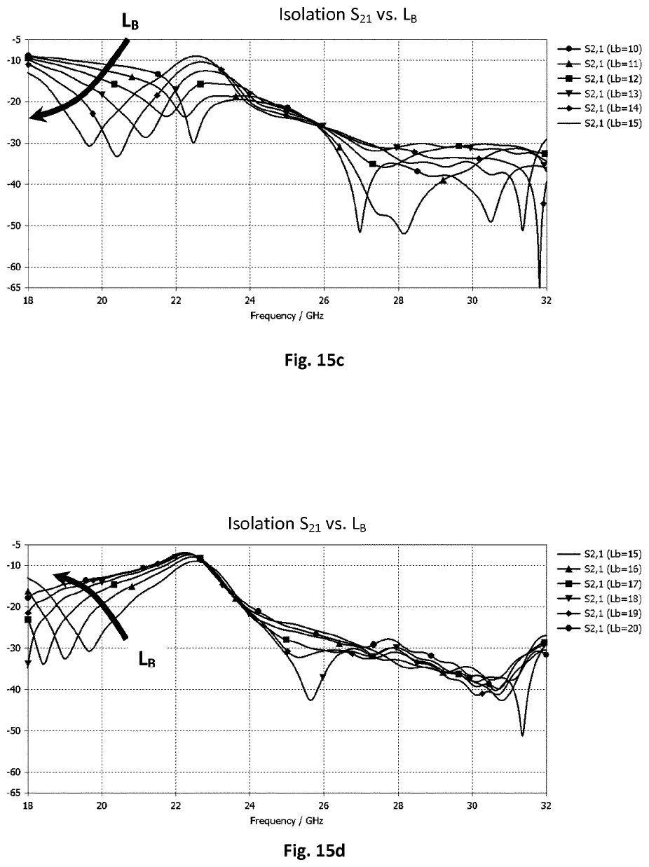

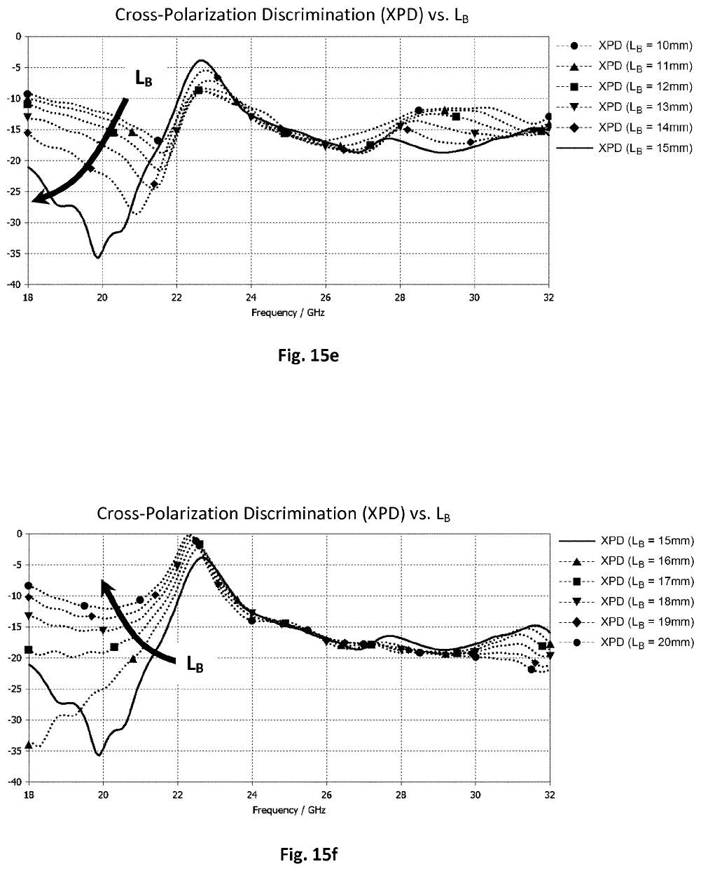

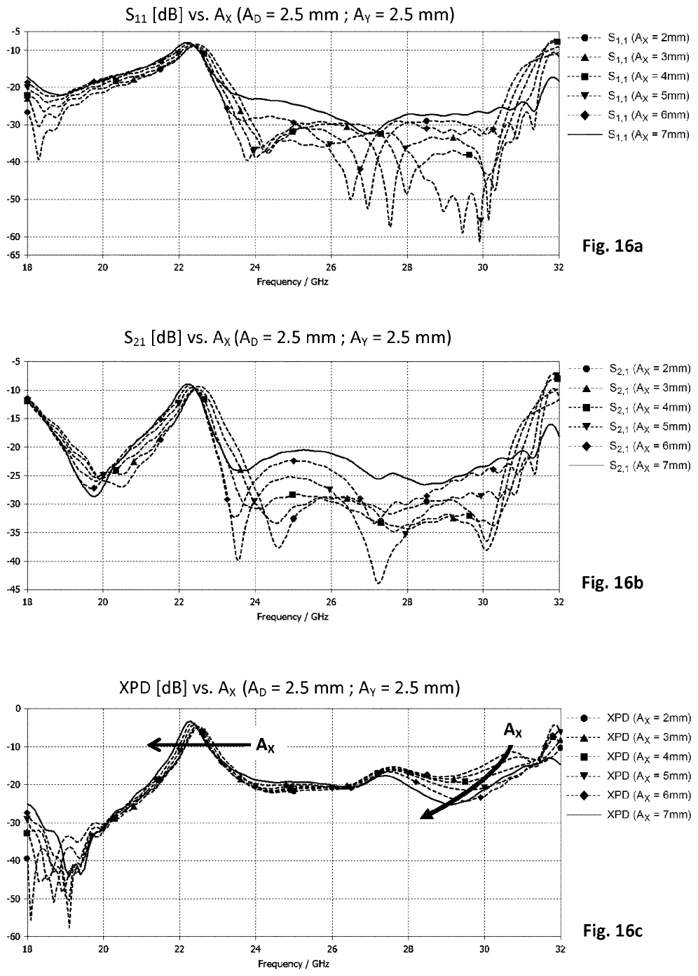

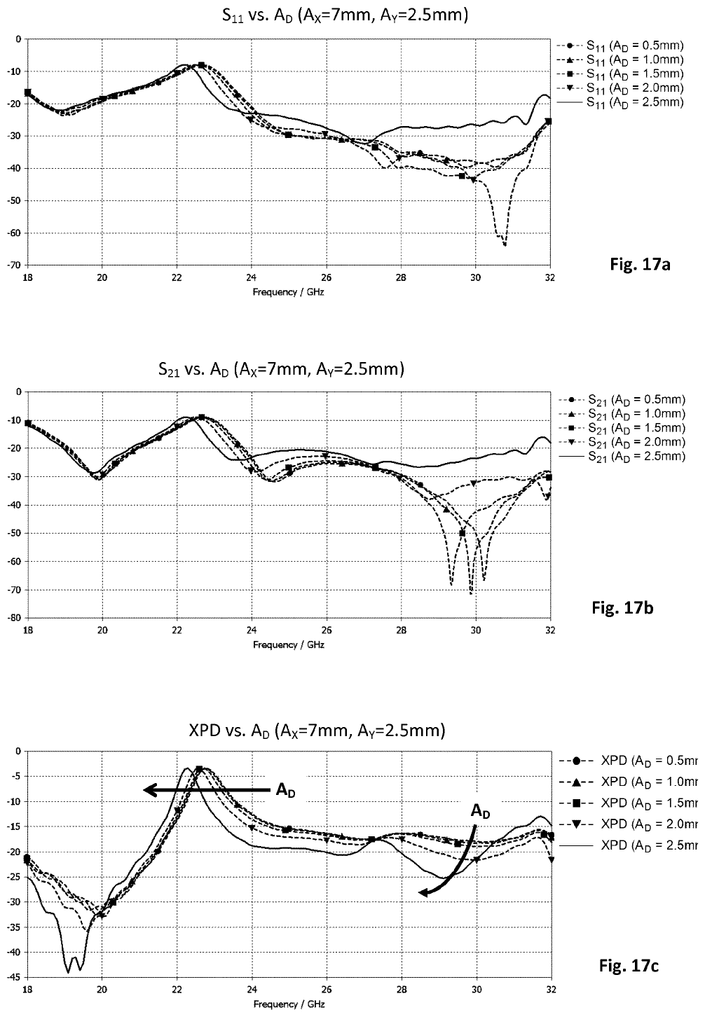

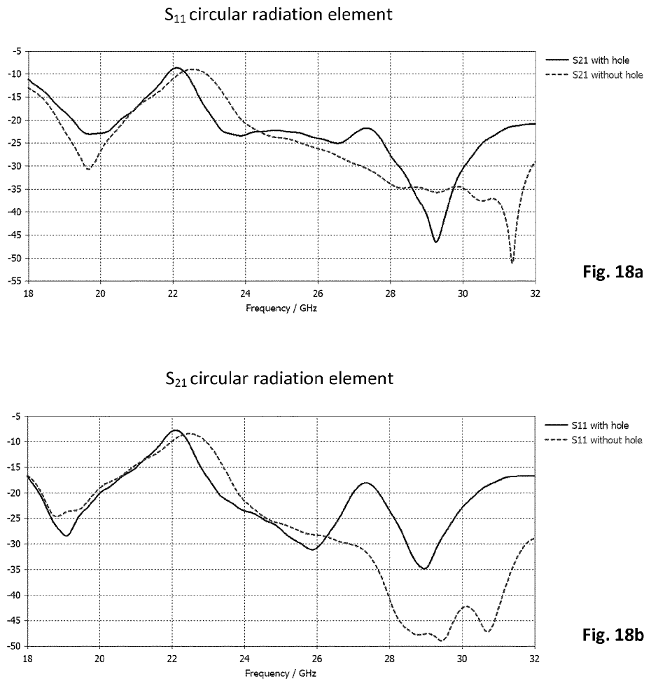

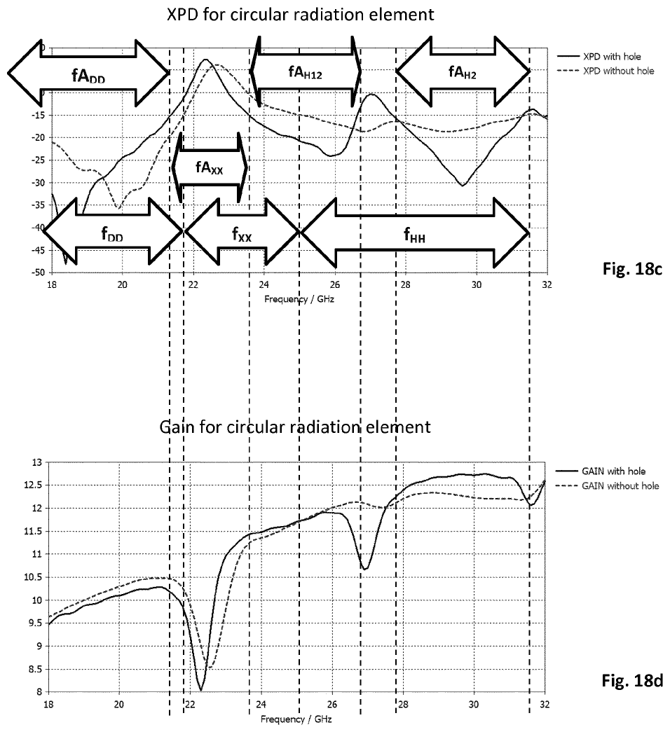

The invention may be also used with a three step polarizer, as shown in FIG. 3. The septum 4 opens a first gap, having a first gap width W₁ at a gap length of L₁, a second gap having a second gap width W₂ at a gap length of L₂, and a third gap having a third gap width W₃ at a third gap length of L₃. An example of dimensions is shown below in a second table:

| Parameter | Value |
|---|---|
| a_{○} | 11.1 mm |
| L₁ | 3.8 mm |
| L₂ | 3.7 mm |
| L₂ | 4.4 mm |
| W₁ | 5.1 mm |
| W₂ | 6.2 mm |
| W₂ | 8.3 mm |
| Performance | Fig. 10a-10b |

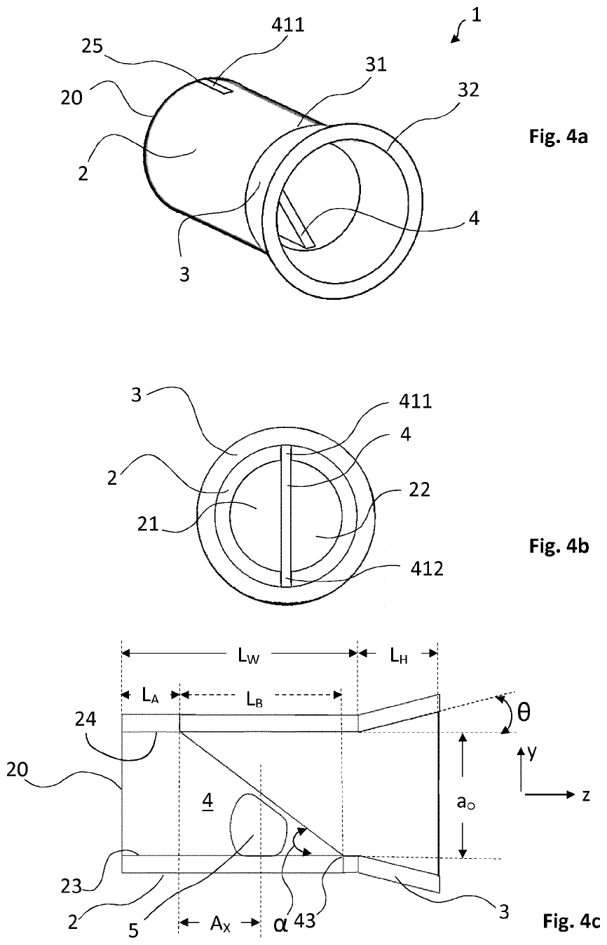

FIG. 4a shows in a three-dimensional view a radiating element 1 with a triangular shaped septum 4. FIG. 4c shows a cross section of a side view of the radiating element 1, which reveals the geometry of the triangular septum 4. The triangular septum 4 lays completely in the vertical cross section of the cylindrical waveguide 2. Typical design for dual-polarization horns in prior art make use of septum polarizers made of multi-section stepped structures. The novelty of the proposed design lies is the septum geometry. An optional, properly shaped and located opening 5 arranged on the septum 4 allows for a further improved performance. This design allows for an extremely broadband operation, which enables the antenna to cover the whole receive, RX, and transmit, TX, frequency bands for Ka-band satellite communications (18-21 GHz in RX, 28-31 GHz in TX) with very good cross-polarization levels.

These frequencies are examples used in the measurement diagrams provided here within. The person skilled in the art readily appreciates that the radiating element's design is scalable in frequency. Thus the invention can be used with frequency bands below or above the mentioned Ka band. In particular, when scaling down the design to the Ku-band, a trackable dual linear polarization can be obtained by properly combining the two orthogonal circular polarizations. In order to be able to use short radiating elements prior art designs use two separate antenna elements in order to be able to span a wide frequency band; first antenna elements adapted for the RX band and second antenna elements adapted by a different geometry for the TX band. Alternatively the few prior art designs which claim to cover a frequency range from 100% to 200% use long septum with seven or more steps. The advantage provided by the invention therefore is that the total length of a radiating element which is suitable to be used simultaneously for both RX and TX band in comparison to those extreme broadband radiating elements with stepped septum is drastically reduced. Since the whole antenna aperture is simultaneously employed both in TX and RX, the resulting antenna gain, given a fixed total area, is twice (or equivalently 3 dB higher) than that obtained by a prior art design using one half of the aperture for TX and the other half for RX.

The septum 4 is made of a conductive material and comprises a rectangular area 41 and triangular area 42 or quasi-triangular area 46 connected with a common base side 40 to each other. In the embodiment the septum has a thickness of 1 mm, but it can be thinner or thicker without having an effect on the invention. The rectangular area 41 and the triangular area 42 or quasi-triangular area 46 extends in radial direction y of the cylindrical waveguide 2 between a first inner side 23 and second inner side 24 of the waveguide element 2. As the rectangular base area 41 and the triangular area 42 or quasi-triangular area 46 lay completely in the vertical cross section of the cylindrical waveguide 2, the first inner side 23 and the second inner side 24 are strictly opposite to each other. As a consequence the length of the base side 40 is identical to the inner diameter aₒ of the cylindrical waveguide 2. The rectangular area 41 is purely a constructional element and has no influence on the electrical characteristics of the septum 4. In effect, the rectangular area could be totally omitted, but however this would weaken the mechanical stability of the septum. The length L_{A} of the rectangular area in axial direction z is chosen to be approximately 5 mm as this gives sufficient mechanical support. In fact, in another aspect of the invention, the rectangular area 41 extends on both sides of the rectangular area 41 outwards, along the common base side 40, creating two tongues 411, 412 (FIG. 4a). These tongues 411, 412 allow for sliding the septum 4 into two grooves 25 which have been cut along the first inner side 23 and the second inner side 24 of the waveguide element. The gap of the grooves 25 is adapted to the thickness of the septum 4 such that the septum 4 is clamped in the grooves 25 and does not need any other form of fixation.

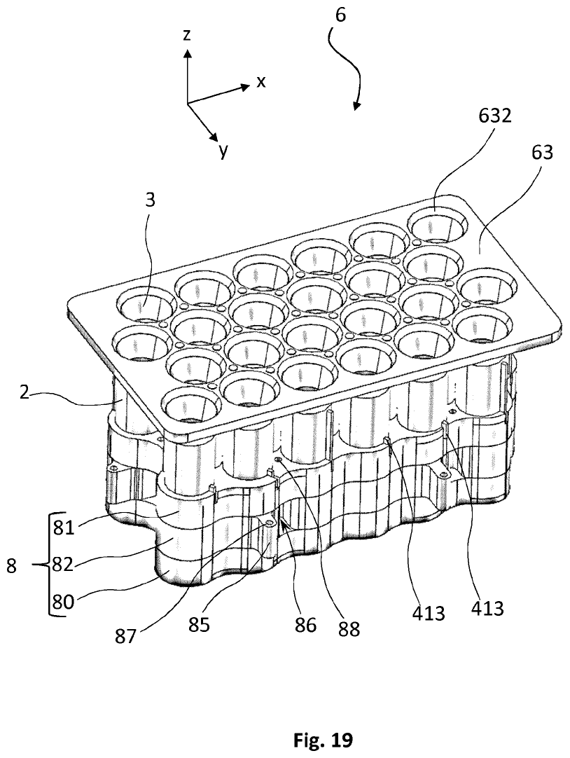

In another aspect of the invention the tongues 411, 412 extend even beyond the outer diameter of the cylindrical waveguide element 2. As shown in FIG. 19 these extended tongues 413 serve as a mounting aid when assembling a plurality of radiating elements to antenna arrays an allow for easy alignment of all septum in an antenna array.

The triangular area 42 or quasi-triangular area 46 extends on the first inner side 23 of the waveguide 2 from the base side 40 parallel to the middle axis of the waveguide 2 in direction to the horn 2 and culminates in a tip 43 of the triangular area 42 or quasi-triangular area 46. From the tip 43 a straight edge 45 of the triangular 42, respectively a smoothly curved edge 47 of the quasi-triangular area leads back to a point where the base side 40 is in contact with the second inner side 24 of the waveguide 2. This point will be termed in the following vertex 44. As a consequence of the described geometry the straight edge 45 of the triangular 42 is the longest side of the triangular area 44, which in case of a triangle is known as a hypotenuse. In case of a quasi-triangular area of the septum 4 the longest side 47 of the quasi-triangular area 46 between the vertex 44 and the tip 43 is a smooth curve, or in mathematical terms a class C1 function when vertex 44 and tip 43 as the transitions to the inner wall are excluded. In mathematical analysis a class C1 consists of all differentiable functions whose derivative is continuous; such functions are called continuously differentiable.

FIG. 5d shows the function y=f(z), wherein f(z) is the hypotenuse of the triangle 42 of the septum depicted in FIG. 5a. As the hypotenuse of a triangle is a straight line and as such is smooth without any steps or edges it is a special case of a C1 function. FIG. 5e is another example of a C1 function, in which the function is a concave graph and the septum 4 shown in FIG. 5b has a concave shaped edge 47. FIG. 5f is another example of a C1 function, in which the function is a convex graph and the septum 4 shown in FIG. 5c has a convex shaped edge 49. Other examples of suitable edges of the quasi-triangular areas are segments of a sinusoidal, polynomial, logarithmic or exponential graphs.

The distance between the point where the base side 40 of the triangular area or quasi-triangular area meets the first inner side 23 of the inner wall of the waveguide 2 and the tip 43 is termed in the following the length L_{B} of the triangular area 42 or quasi-triangular area 46. The length L_{B} of the triangular area 42 or quasi-triangular area 46 preferably is in between half of the wavelength λ_{C1} of the fundamental mode cut-off frequency f_{C1} and three times of the wavelength λ_{C1} of the fundamental mode cut-off frequency f_{C1}. For an improved performance, the diameter aₒ of the inner wall of the waveguide 2 and the length L_{B} of the triangle 42 should be chosen such that the hypotenuse of the triangle 42 and the inner wall of the waveguide 2 result in a septum angle α in the range of 25 to 45 degrees, preferably around 37 degrees. As the length L_{B} is the product of a cotangent function of the septum angle α and the inner diameter aₒ, L_{B} aₒ×cotan(a). Thus the septum length L_{B} is in a range of 0.8 . . . 1.6 of the inner diameter aₒ. This is also the range of the septum length L_{B} in case of a quasi-triangular septum 46, 48, which has no constant septum angle α. The person skilled in the art will appreciate that in case a different requirement is needed another angle outside the range given above could be more appropriate.

In another aspect of the invention, the septum 4 comprises an opening 5 creating a connection between the first subsection 21 and the second subsection 22. Preferably, the centre of the opening 5 is placed in axial direction z of the radiating element 1 between one quarter and three quarters of the length of the length L_{B} of the triangular area 42 or quasi-triangular area 46. Measurements in the Ka-band have shown that this opening 5 reduces cross polarization from −15 dB to at least −20 dB.

FIG. 6a-6c show an embodiment of the invention applied to a radiating element with a square cross section 1. In this case the square radiating element has a triangular septum 4. FIG. 6a shows a perspective view on the top part of the square radiating element 1. The square radiating element 1 comprises a radiating element waveguide 2 and in extension of that waveguide 2 a horn 3. FIG. 6b shows a view of the bottom of the square radiating element 1 and FIG. 6c shows in a cross section the triangular septum 4.

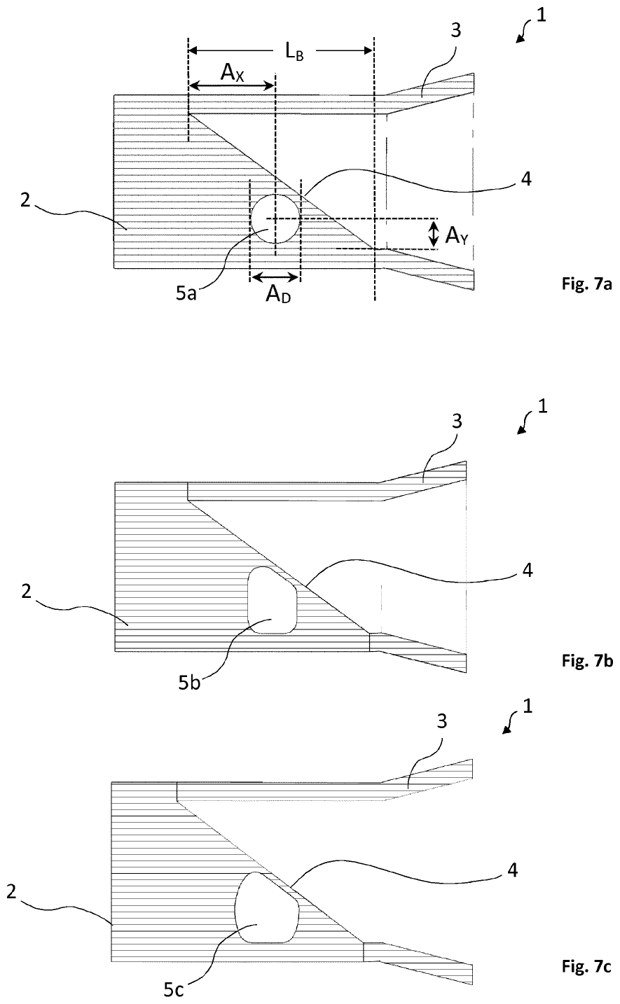

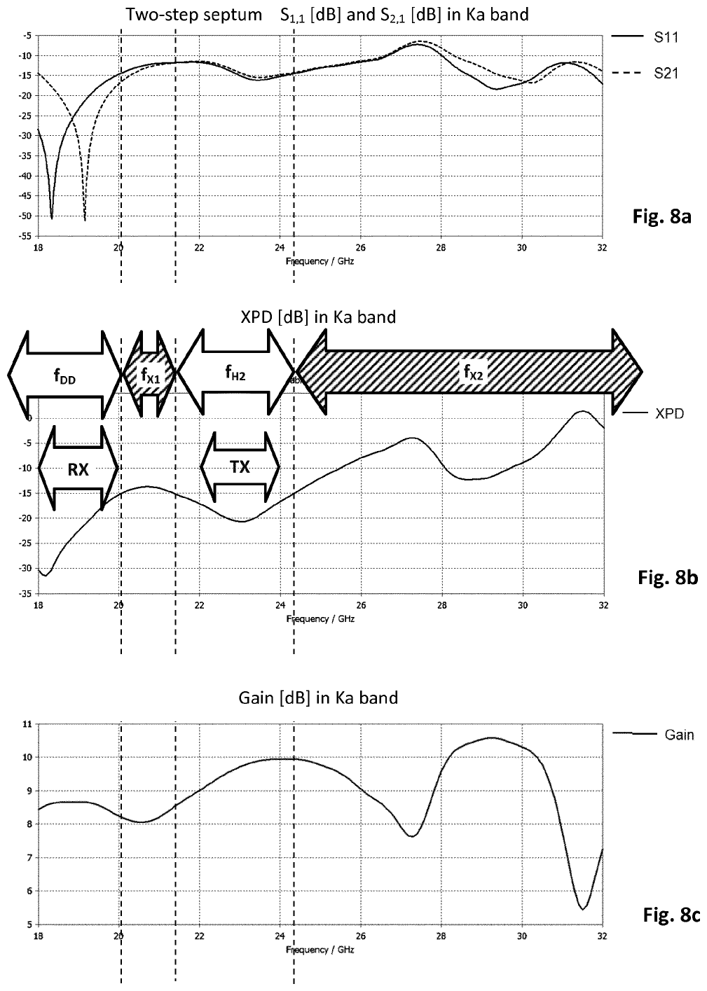

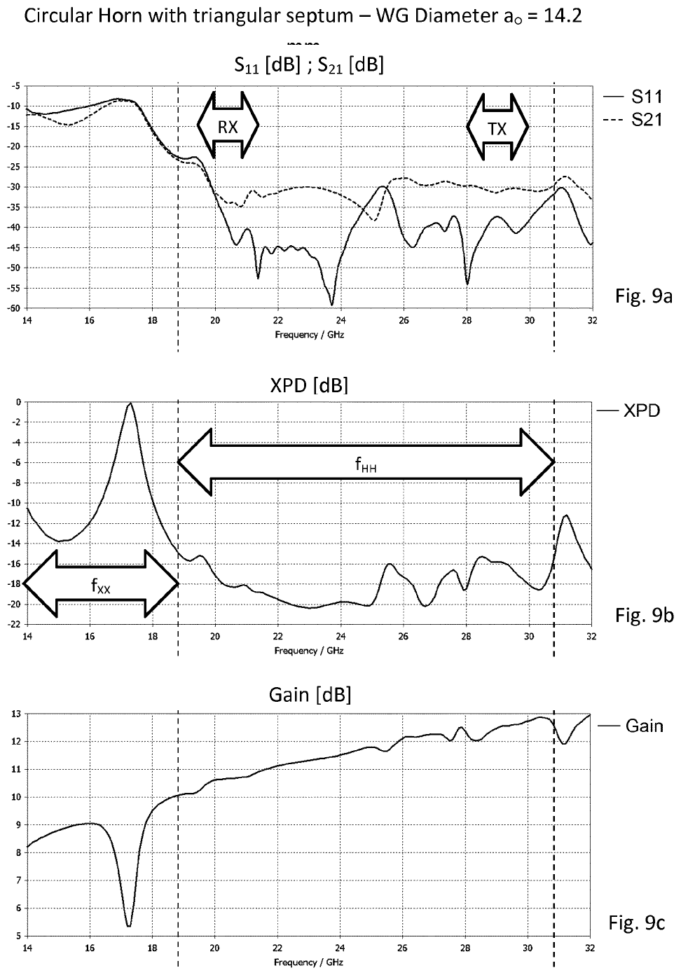

In FIG. 7 an opening 5 in the septum is shown, having different shapes which vary from a simple circle 5a to a more complex shape 5b, 5c like shown in FIGS. 7b and 7c. In particular the shapes shown 5b, 5c are the result of a combined optimization of the three parameters S11, S21 and XPD acting on the aperture geometry, with different goal functions (each of which generated a different shape).

Single-Module Antenna Design

The radiating element 1 could be used as a single element of a microwave antenna. However, as the antenna of this embodiment is designed for communication with satellites in the Ka-band, a single radiating element would not achieve the necessary gain. FIG. 19 shows an embodiment in which twenty-four radiating elements 1 are arranged as an antenna module 6 with four rows of radiating elements 1, each row comprising six radiating elements 1. The radiating elements 1 are hereby placed so that the middle axis of all radiating elements 1 are parallel to each other, thus directing in the same direction Z.

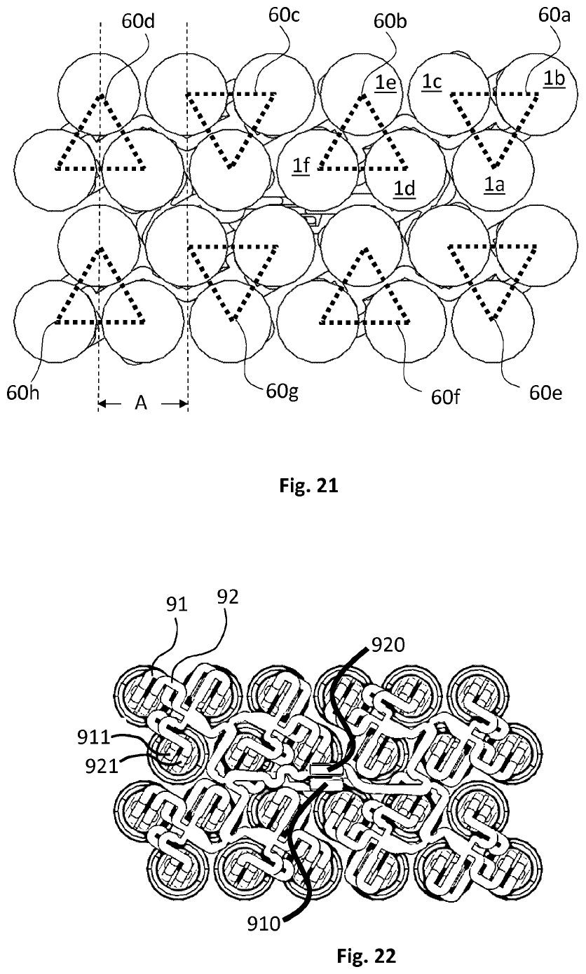

The radiating elements 1 are spaced apart from each other, for example the middle axis of one radiating element to a middle axis of a neighboured radiating element 1 is arranged apart with a distance A=18 mm (see FIG. 21). The radiating elements 1 of each second row are displaced to a neighbouring row. Thus the middle axis of two neighboured radiating elements of a row form with a radiating element 1 of the row below or above an equilateral triangle 60. The equilateral triangle 60 allows for a compact placement of the radiating elements 1.

Three radiating elements 1a, 1b, 1c form a group or as called in the following a triple. In the embodiment shown in FIG. 21 a first triple of radiating elements 1a, 1b, 1c is arranged in a first triangle 60a with the tip of the first triangle 60a pointing downwards with respect to the drawing. In the following each triple 60a of radiating elements 1a, 1b. 1c is referenced to with the same reference sign as for their geometrical arrangement, the triangle 60a. A second triple 60b of radiating elements 1d, 1e, 1f is arranged to the left of the first triple 60a with the tip of the triangle 60b pointing upwards in the drawing. A third triple 60c is arranged left to the second triple 60b in a third triangle 60c with the tip of the third triangle 60c pointing downwards. A fourth triple 60d is arranged to the left of the third triple 60c with the tip of the fourth triangle 60d pointing upwards. A fifth triple 60e is arranged below the first triple 60a with the tip of the fifth triangle 60e pointing downwards. A sixth triple 60f is arranged below the second triple 60b with the tip of the sixth triangle 60f pointing upwards. A seventh triple 60e is arranged below the second triple 60b with the tip of the seventh triangle 60g pointing downwards. And an eight triple 60h is arranged below the fourth triple 60d with the tip of the eight triangle 60h pointing upwards. Thus all triples 60a, 60b, 60c, 60d, 60e, 60f, 60g, 60h form a lattice with very little space between neighboured radiating elements. They also form an almost rectangular block of twenty-four radiating elements 1 arranged in four rows, with six elements per row.

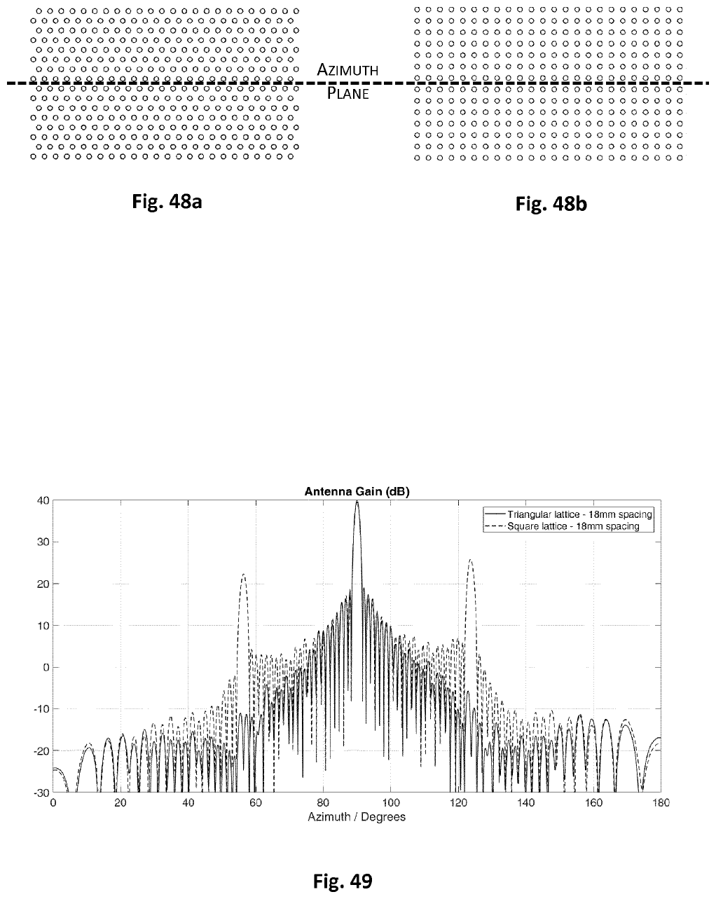

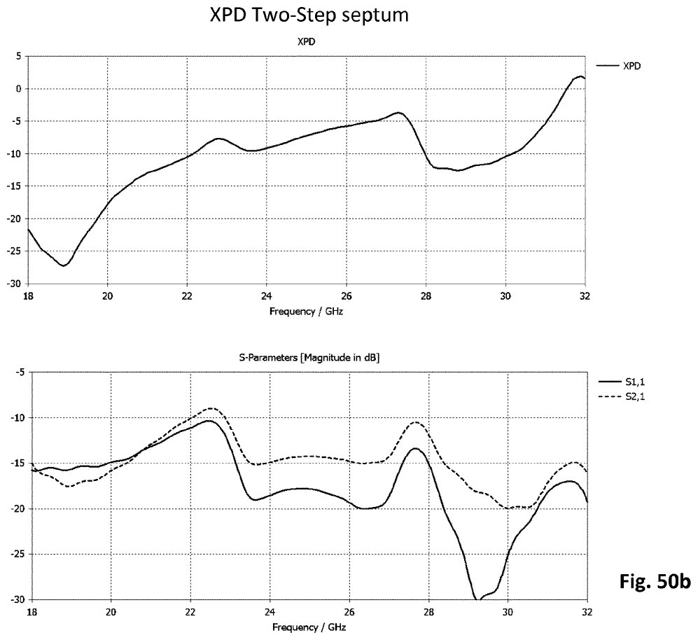

The triangular lattice has the further advantage of a strong reduction of the side lobe level in the horizontal cut-plane compared to if the radiating elements would be arranged in a square lattice. Consequently the interferences in receive mode are reduced and the EIRP in transmit mode is increased. This makes it possible to achieve compliance with regulations, such as ETSI and ITU EIRP masks, with superior EIRP levels with respect of prior art, for a given TX aperture. This effect is increased by the number of radiating elements arranged in a triangular lattice. FIG. 49 shows this effect for a triangular lattice of twenty-four times sixteen radiating elements 1 at a frequency of 30 GHz. With reference to FIGS. 48a and 48b, where a triangular and a square lattice are respectively shown, FIG. 49 shows in particular the comparison in performance on the azimuth-plane radiation pattern for the two above mentioned array lattices: it results evident that sidelobe levels in the case of a triangular lattice are much lower than those in the case of a square lattice with the same element-to-element spacing.

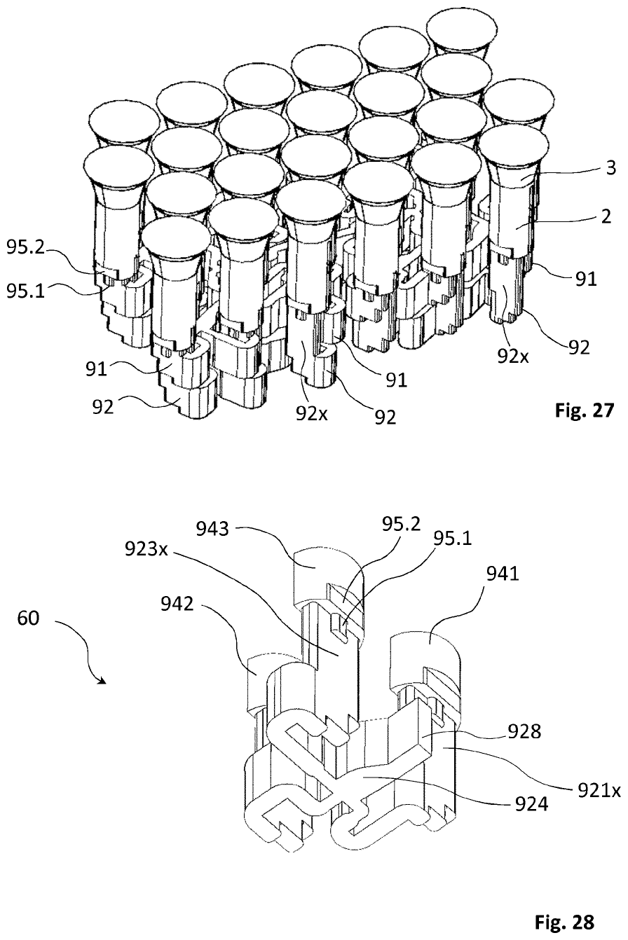

Turning now shortly to FIG. 27, this figure shows the arrangement of the radiating elements 1 represented by their air volume in a perspective view. As in all figures, which show air volumes, the air volumes are depicted as non-transparent. That means, an air volume closer to the viewer obstructs the view to an air volume that is behind the air volume that is closer to the viewer. Details of this air volume will be discussed later.

For the moment we look in FIG. 22 to the air volume of the antenna module 6 from the bottom. Therefore the order of the radiating elements 1 in comparison to FIG. 21 are mirrored with respect to the vertical extension of the drawing. Twenty-four first input/output ports 911 are connected with a module input/output port 910 close to the centre of the module 6 by a first beam forming network 91. Similarly, twenty-four second input/output ports 921 are connected with a second module input/output port 920 close to the centre of the module 6 by a second beam forming network 92. The first beam forming network 91 and the second beam forming network 91 are provided by the beam forming network tile 8, as shown in FIG. 19. All first input/output ports 911 face the corresponding first half-circular waveguides 21 of the plurality of radiating elements 1 and all second input/output ports 921 face the second half-circular waveguides 22, respectively. In this embodiment the cross-section of the first half-circular waveguide 21 and the cross-section of the second half-circular waveguide 22 are such that the waveguides are unimodal, i.e. only one waveguide mode can propagate in the frequency range of operation of 18-31 GHz. In this manner the first half-circular waveguide 21 and the second half-circular waveguide 22 are each associated with an orthogonal circular polarization; for example the first half-circular waveguide 21 is associated with a left-hand circular polarization LHCP and the second half-circular waveguide 22 is associated with a right-hand circular polarization RHCP.

It should be noted that the term “beam forming network” is used in this document to indicate a network, which distributes the signals from a common input port 910 to all radiating elements 1, and vice versa from al radiating elements 1 to a common output port 920, regardless of the beam pointing direction. One special application of a beam forming network is an antenna with a broadside beam, orthogonal to the array plane x-y, which is fed by a beam forming network where all signals fed into a common input port 910 arrive with the same phase at each radiating element 1 or arrive from each radiating element 1 with the same phase at a common output port 920. In this document the term “beam forming network” particularly refers to the mechanical parts whereas the air volumes enclosed by the walls of the beam forming networks are referred here within as module waveguide layers 91, 92. The waveguides of the module waveguide layers 91, 92 are designed as walls having a rectangular cross section with a pair of narrow walls and a pair of broader walls. Due to the manufacturing process the waveguide walls may have rounded corner and edges. With respect to common conventions the E-plane of a waveguide, is the plane parallel to the transverse E-field, which is the plane parallel to the narrow wall of the waveguide; and the H-plane, is the plane parallel to the transverse H-field, is the plane parallel to the broad walls of the waveguide

An object of the invention was to create antenna modules 6 which can be easily arranged into larger antenna arrangements 100 and at the same time to optimize weight and dimension of such antenna arrangements 100. Albeit a person skilled in the art will appreciate that for an antenna module 6 in general any number n of rows and any number m of radiating elements 1 for each row could be chosen, an embodiment with four rows, and six elements per row has proven to provide the optimum size for an antenna module 6 in terms of a total volume and weight when several modules are combined to an antenna arrangement 100, as shown in FIG. 44 This size of four rows, and six elements per row allows to fit all waveguides in exactly two physical module waveguide layer 91, 92 when the first module waveguide layer 91 feeds the first half-circular waveguides 21 and a second physical module waveguide layer 92 feeds the second half-circular waveguides 22. For a given waveguide cross section, the available space below the antenna elements 1 sets a limit to the total number of antenna elements 1 that can be fed by a single module waveguide layer. Any larger number of radiating elements 1 per module would require additional physical layers to route the additional elements. For this reason a first module waveguide layer 91 of the beam forming network tile 8 accommodates primarily the first beam forming network and a second module waveguide layer 92, which is arranged below the first module waveguide layer 91 of the beam forming network tile 8, accommodates primarily the second beam forming network. Reducing the total number of module waveguide layers to a number of two saves material and weight for an antenna array. Less weight for example is crucial when antenna arrangements are used in tracking arrangements where the antenna array has to be actuated quickly as the total moment of inertia is minimized.

As described earlier, FIG. 19 shows a single antenna module 6 comprising four rows of radiating elements 1 with six radiating elements in a row. In this embodiment the antenna module 6 comprises on the bottom of beam forming network tile 8 a first input/output port 910 and a second module input/output port 920, one input/output port for each polarization. These module input/output ports 910, 920 cannot be seen in FIG. 19 as they are concealed by beam forming network tile 8, but the first module input/output port 910 and the second module input/output port 920 can be seen for example in FIG. 22, which shows the air volume of the antenna from the bottom. Via a first module waveguide layer 91 inside the beam forming network tile 8 the input or output signal of the first module input/output port 910 is distributed to the twenty-four first input/output ports 911, 912, 913 below the first half-circular waveguides 21. Similarly via a second module waveguide layer 92 inside the beam forming network tile 8 the input or output signal of the second module input/output port 920 is distributed to the twenty-four second input/output ports 921, 922, 923 below the second half-circular waveguides 22.

In this embodiment the first and the second module waveguide layers 91, 92 are used to feed two differently polarized signals in two separate, independent module waveguide layers 91, 92. In one embodiment the first module waveguide layer 91 is associated with a left-hand circular polarized signal LHCP and the second module waveguide layer 92 is associated with a right-hand circular polarized signal RHCP. Associated means that the first module input/output port 910 is connected via the first module waveguide layer 91 to each of the first half-circular waveguides 21 of each radiating element 1 and that the second module input/output port 920 is connected via the second module waveguide layer 92 to each of the second half-circular waveguides 22 of each radiating element 1.

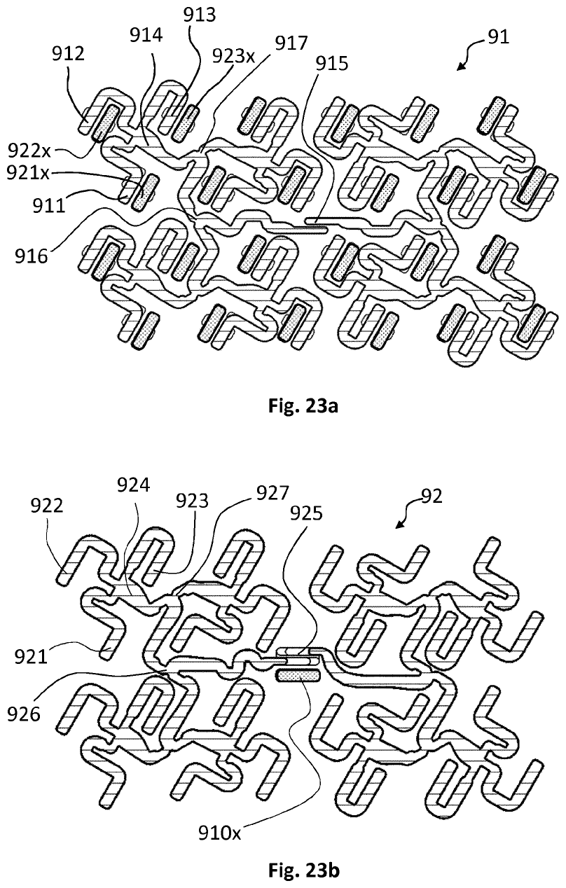

FIG. 27 shows a 3-dimensional view of the air volume inside the antenna module 6 of FIG. 19. It can be seen that the first module waveguide layer 91, primarily distributes the microwave signals in a layer next to the bottom of the radiating elements 1, whereas the second module waveguide layer 92 primarily distributes microwave signals in a second layer below the first layer. Only directly under the second half-circular waveguides 22 a vertical channel 92x passes through the first module waveguide layer 91, connecting the second module waveguide layer 92 with the second half-circular waveguides 22. The same situation is depicted in FIG. 22, which shows the air volume of the antenna module 6 from the bottom of the antenna module 6, but where the view on the first layer 91 is obstructed by the air volume of the second layer 92. To improve conciseness FIG. 23a shows the air volume of the first module waveguide layer 91 only and FIG. 23b shows the air volume inside the antenna module for the second module waveguide layer 92 only. As can be seen in FIG. 23a and FIG. 23b the air volumes of the first module waveguide layer 91 and the second module waveguide layer 92 have identical shapes in the horizontal plane. The only difference is, that the first module waveguide layer 91 has to accommodate the vertical through holes 921x, 922x, 923x where the microwave signals pass from the second module waveguide layer 91 to the second half-circular waveguides 22 of each radiating element 1. Please note that depending on the point of view, the vertical through holes 921x, 922x, 923x are termed through holes when seen from a mechanical point of view, i.e. when speaking of perforations of the first and second plate 81, 82. At the same time the through holes 921x, 922x, 923x are termed passages 92x when seen from the air volume, as the air volume of the second module waveguide layer 92 passes through the first module waveguide layer.

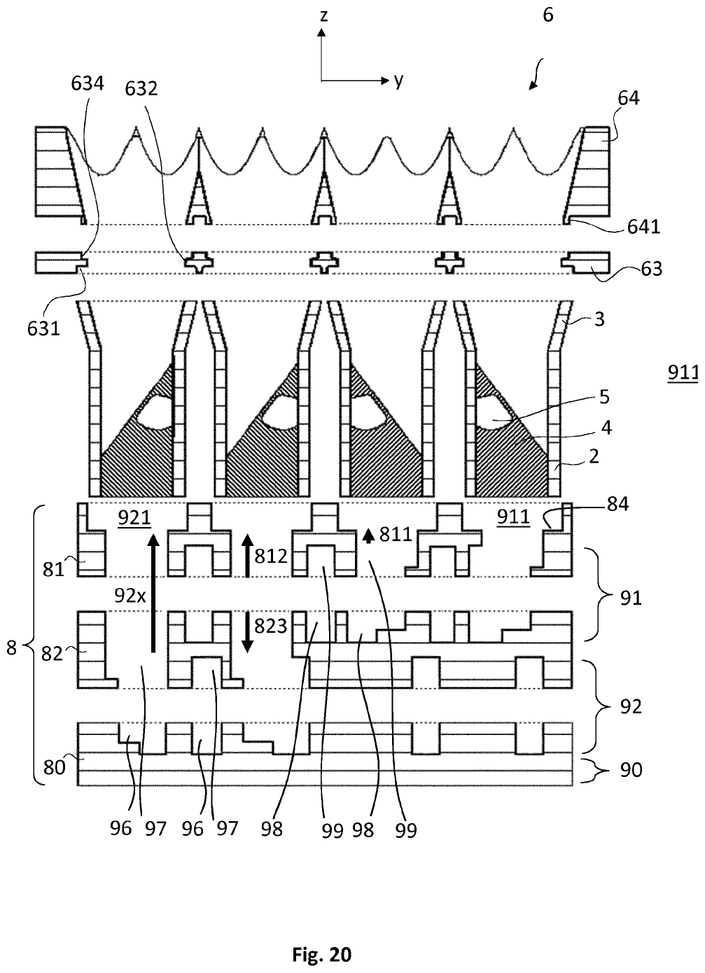

FIG. 20 shows the single antenna module 6 of FIG. 19 in a schematic sectional view with its different elements stacked over each other. In order to increase conciseness each element is shown vertically apart from the elements below or above. As shown in FIG. 20 the beam forming network tile 8 comprises a first beam forming plate 81, a second beam forming plate 82 and a third beam forming plate 80. The third beam forming plate 80 is termed in the following base beam forming plate 80. When assembled, the first beam forming plate 81 sits tightly on top of the second beam forming plate 82, and the second beam forming plate 82 sits tightly on top of the base beam forming plate 80. Tightly means that there is no substantial leakage of microwaves. The first beam forming plate 81, the second beam forming plate 82 and the base beam forming plate 80 in the assembled state may be pressed together by the forces of screws (not shown) or rivets (not shown).

The base beam forming plate 80 has grooves 96 in the top part base beam forming plate 80 which correspond to grooves 97 in the bottom part of the second beam forming plate 82. When assembled the grooves 96 in the top part of the base beam forming plate 80 and the grooves 97 in the bottom part of the second beam forming plate 82 create the air volume of the second module waveguide layer 92. The second module input/output port 920 on the bottom face of the base beam forming plate 80 is connected with a short internal vertical passage to the grooves in the top of the base beam forming plate 80. Thus the air volume of the second module waveguide layer 92 is in communication with the second module input/output port 920. The proposed solution is based on waveguide technology and no dielectrics are employed. This guarantees the maximum antenna efficiency and very high power handling, with no thermal issues.

The second beam forming plate 82 has grooves 98 in the top part second beam forming plate 82 which correspond to grooves 99 in the bottom part of the first beam forming plate 81. When assembled the grooves 98 in the top part of the second beam forming plate 82 and the grooves 99 in the bottom part of the first beam forming plate 81 create the air volume of the first module waveguide layer 91. The first module input/output port 910 on the bottom face of the base beam forming plate 80 is connected with an internal vertical passage (910x in FIG. 23b, not visible in the cross cut of FIG. 20), which passes through the second beam forming plate 82 to the grooves 98 in the top of the first beam forming plate 81. Thus the air volume of the first module waveguide layer 91 is in communication with the first module input/output port 910.

As can be easily seen in the cross section of FIG. 20, the first module waveguide layer 91 and the second module waveguide layer 92 are arranged vertically, i.e. the waveguide E-plane is parallel to plane x-y of the first beam forming plate 81, the second beam forming plate 82, and the base beam forming plate 80. This allows for a maximum use of the space that is available to route the waveguides in each beam forming layer. As a consequence each plate 81, 82, 80 needs to be thicker, than if the waveguides would be arranged horizontally, i.e. with the waveguide H-plane parallel to the plate first beam forming plate 81, the second beam forming plate 82, and the base beam forming plate 80.

The top part of the first beam forming plate 81 comprises recesses 84 to accommodate the bottom parts 10 of the radiating elements 1. Slots (not shown) in the first beam forming plate 81 are machined into appropriate locations such that when radiating elements 1 with extending tongues 413 are placed on the top side of the first beam forming plate 81 extending tongues 413 and the slots interlock. Such all radiating elements are automatically aligned with each other and the slots hinder the round radiating elements to rotate within the recesses 84.

As shown in FIG. 23a the grooves that constitute the first module waveguide layer 91 branch off in several steps from the first module input/output port 910 into twenty-four individual input/output ports which are located each below the first half-circular waveguides 21. Similarly, as shown in FIG. 23b the grooves that constitute the second module waveguide layer 92 branch off in several steps from the second module input/output port 920 into twenty-four individual input/output ports which are located each below the second half-circular waveguides 22. Individual vertical passages 92x from the grooves in the top of the base beam forming plate 80 to the individual recesses 84 connect each first input/output port 921 with the first half-circular waveguides 21 that are located above each first input/output port 921. In order not to cut through the air volume of the first module waveguide layer 91 the grooves constituting the air volume of the first module waveguide layer 91 have to be routed such that they have clearance to the vertical passages 92x extending from the air volumes of the second module waveguide layer 92 to the second half-circular waveguides 22.

A top plate 63 is mounted on top of the plurality of the twenty-four radiating elements 1. On the bottom face of the top plate 63 recesses, in the following termed as horn recesses 631 are arranged, the diameter of which match the outer diameter of the mouth 32 of each horn 3. Thus when the top plate 63 is placed on top of the radiating elements 1, the mouths 32 of the horns 3 interlock with the horn recesses 631. By fixing the top plate 63 to the beam forming network tile 8, for example with screws or rivets 633, all radiating elements 1 are clamped between the beam forming network tile 8 and the top plate 63, thus being mechanically secured.

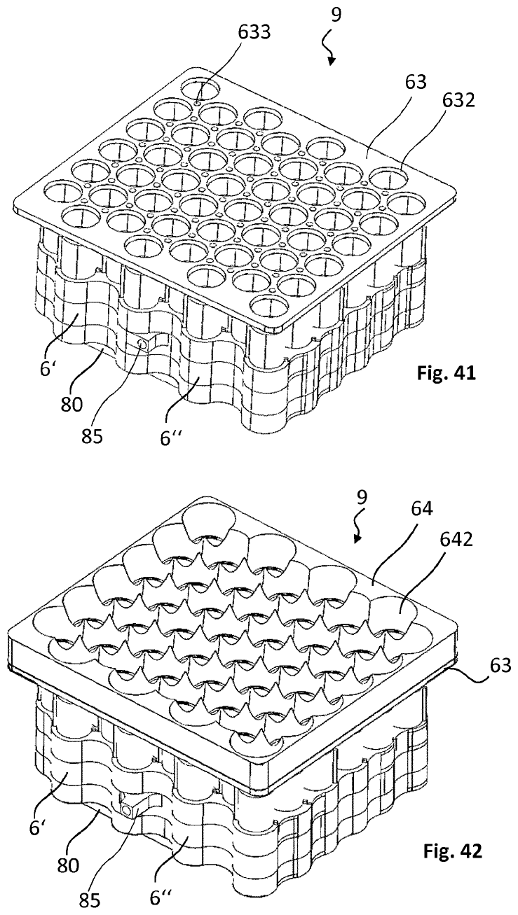

In another aspect of the invention the top plate 63 has funnel shaped passages 632 with the same flaring angle as the horns 3 and which extend each horn 3 of the radiating elements 1 in axial direction z. These horn extensions 632 increase the antenna gain and reduce the diffraction and spurious resonances that may be produced in the regions between each radiating element 1. Thus the top plate 63 is not only used to fix the radiating elements 1 in the antenna module 6, but also improves, even if it is only a small contribution, the performance of each individual radiating element 1. As shown in FIG. 19, the horizontal dimensions of the top plate 63 may correspond with the horizontal dimension of a module 6 so that each module 6 is self-contained. As shown in FIG. 41 the horizontal dimensions of the top plate 63 may also cover two or more modules 6 which are arranged in an antenna array 9.

Optionally a thin membrane (not shown), that substantially does not attenuate the microwaves, may be fixed to the top face of the top plate 63. This membrane protects the inside of the radiating element 1, for example against rain, or other objects that otherwise may fall into the inside a radiating element 1.

Optionally a gain-enhancing plate 64 may be mounted, for example by screws or rivets, on top of the top plate 63, as shown in FIG. 42. The gain-enhancing plate 64 extends the flare of the individual horns 3 in axial direction z. In this embodiment the radiating elements 1 have been placed apart by a distance A which is larger than the outer diameter of the horns 3, in order to leave some material between neighboured radiating elements 1 allowing to provide the recesses 631 in the top plate for securely holding the horns 3 of the radiating elements 1 in place. This extra space between the horn mouths 32 is used in the gain-enhancing plate for extending the flares of each individual horn 3 until neighboured inner flare walls 642 of the gain-enhancing plate 64 intersect. This gain-enhancing plate 64 essentially increases the gain of a single radiating element 1 and therefore that of the whole antenna. In addition a better filtering of side lobe level is applied, further increasing the antenna directivity and gain. Top plate 63 and gain-enhancing plate 64 in this embodiment have been chosen as separate items as this allows for a flexible and easy assembly of the antenna modules 6. The person skilled in the art however will appreciate that top plate 63 and gain-enhancing plate 64 may be integrated in a single plate, without departing from the invention.

As shown in FIG. 21 and explained already before, the radiating elements 1 of the antenna module 6 are arranged in a triangular lattice. This actually creates a challenge as the object to reduce the distance A between radiating elements leaves little space for the module waveguide layers 91, 92. An important property of the first module waveguide layer 91 and the second module waveguide layer 92 is that every individual first input/output port 910 and every individual second input/output port 920 must be in phase and preferably receive or transmit at equal signal amplitudes. Another challenge is that vertical passages 92x from a lower module waveguide layer 92 to the radiating element 1 should not cut through any air volume of another layer that is between the lower layer and the radiating elements 1. The solution to meet this requirement is to arrange the radiating elements 1 of a triangular lattice in base triangles 60 and connect each triple 60a of radiating elements 1 by a 3-way power divider/combiner 914. As an antenna module 6 is composed of twenty-four radiating elements 1 each antenna module 6 is composed of eight triples 60a, 60b, 60c, 60d, 60e, 60f 60g and 60h, as illustrated in FIG. 21.

FIG. 23a shows from the bottom view the first module waveguide layer 91 and FIG. 23b shows equally from the bottom view the second module waveguide layer 92. It is obvious that the geometry of both module waveguide layers 91, 92 are similar, as can be seen in FIG. 22 where the two layers are depicted on top of each other. In addition to the second module waveguide layer 92 FIG. 23a also shows the vertical passages 921x, 922x, 923x for a triple 1a, 1b, 1c from the second module waveguide layer 92 which pass through the layer of the first module waveguide layer 91. Similarly, FIG. 23b shows a single vertical passage 910x from the first module input/output port 910 through the second module waveguide layer 92 to the first module waveguide layer 91. For reason of conciseness, not all input/output ports of the first module waveguide layer and the second module waveguide layer have been labelled with a reference sign. Exemplary for all input/output ports of the first module waveguide layer 91 the first input/output port 911 of the first module waveguide layer 91, the second input/output port 912 of the first module waveguide layer 91 and the third input/output port 913 of the first module waveguide layer 91, which form the first triangle 60a, are referenced in FIG. 23a. Similarly, for all input/output ports of the second module waveguide layer the first input/output port 921 of the second module waveguide layer 92, the second input/output port 922 of the second module waveguide layer 92 and the third input/output port 923 of the second module waveguide layer 92, which form again the first triangle 60, are referenced in FIG. 23b In the following, we speak of 2-way power divider/combiners and 3-way power divider/combiners, respectively, which refers to the geometrical form of the waveguide.

The person skilled in the art naturally understands that depending of the direction the microwave signal travels, a 2-way power divider/combiner functions either as a signal combiner, combining two signals received by the radiating elements 1, or functions as a signal splitter, splitting a transmit signal received at one of the module input ports 910, 920 in two microwave signals of substantially equal power. Similarly, a 3-way power divider/combiner functions either as a signal combiner, combining three signals received by the radiating elements 1, or functions as a signal splitter, splitting a transmit signal received at one of the module input ports 910, 920 in three microwave signals of substantially equal power.

FIG. 23a shows in particular that at a first 2-way power divider/combiner 915 the first module waveguide layer 91 forks into a right-hand side and into a left-hand side of the first module waveguide layer 91. Due to the planar depiction of the x-y plane, in FIG. 23a only two ports of the first 2-way power divider/combiner are visible. A third port of the first 2-way power divider/combiner is placed vertically below the two ports of the first 2-way power divider/combiner and creates the first module input/output port 910. As the third port and the first module input/output port are both outside of the drawing plane x-y they are not visible.

The first 2-way power divider/combiner 915 is located directly above the vertical passage 910x which connects the first module input/output port 910 at the bottom face of module 6 with the first 2-way power divider/combiner 915 in the first module waveguide layer 91. Following the two waveguides that fork off from the first 2-way power divider/combiner 915 in direction to the radiating elements, each waveguide forks off a second time to the upper part and the lower part of the first module waveguide layer 91 in a second 2-way power divider/combiners 916, resulting in four individual waveguides. Following the distribution of the microwave signals further towards the radiating elements 1, the four waveguides each fork a third time in four second 2-way power divider/combiners 917, this time forking off again to the left and the right resulting in eight individual waveguides. Following these eight waveguides they fork for the fourth and last time in the 3-way power divider/combiners 914 into three microwave signals each, a first microwave signal for the first input/output port 911 of the first module waveguide layer 91, a second microwave signal for the second input/output port 912 of the first module waveguide layer 91 and a third microwave signal for the third input/output port 913 of the first module waveguide layer 91.

The first input/output port 911 of the first module waveguide layer 91 is arranged below a first half-circular waveguide 931 of the first module waveguide layer 91. The first half-circular waveguide 931 of the first module waveguide layer 91 is part of the first radiating element 1a. The second input/output port 912 of the first module waveguide layer 91 is arranged below a second half-circular waveguide 932 of the first module waveguide layer 91. The second half-circular waveguide 932 of the first module waveguide layer 91 is part of the second radiating element 1b. The third input/output port 913 of the first module waveguide layer 91 is arranged below a third half-circular waveguide 901 of the first module waveguide layer 91. The third half-circular waveguide 901 of the first module waveguide layer 91 is part of the third radiating element 1c.

Similarly, FIG. 23b shows in particular that at a first 2-way power divider/combiner 925 the second module waveguide layer 92 forks into a right-hand side and into a left-hand side of the second module waveguide layer 92. Again, due to the planar depiction, in FIG. 23b only two ports of the first 2-way power divider/combiner are visible. A third port of the first 2-way power divider/combiner is placed vertically below the two ports of the first 2-way power divider/combiner and is connected to the second module input/output port 920. As the third port and the second module input/output port are both outside of the drawing plane therefore are not visible.

Following each of these two waveguides from the first 2-way power divider/combiner 925 in direction to the radiating elements, each waveguide forks off a second time to the upper part and the lower part of the second module waveguide layer in a second 2-way power divider/combiner 926, resulting in four individual waveguides. Following the distribution of the microwave signals further towards the radiating elements 1, the four waveguides each fork a third time in four second 2-way power divider/combiners 927, this time forking off again to the left and the right resulting in eight individual waveguides. Following these eight waveguides, each forks for a fourth and last time in the 3-way power divider/combiners 924 into three microwave signals each, a first microwave signal for the first input/output port 921 of the second module waveguide layer 92, a second microwave signal for the second input/output port 922 of the second module waveguide layer 92 and a third microwave signal for the third input/output port 923 of the second module waveguide layer 92.

FIG. 28 shows as an air volume in a perspective view the details of a triple 60a. Each triple 60c, 60e, 60g where in FIG. 21 the tip of the triangle is orientated downwards in FIG. 21 is of identical build. Each triple 60b, 60d, 60f, 60h where in FIG. 21 the tip of the triangle is orientated upwards is of identical build and mirrored with respect to the x direction. In the following therefore it suffices to explain only the first triple in more detail. The first input/output port 921 of the second module waveguide layer 92 is arranged below a first half-circular waveguide 941 of the second module waveguide layer 92. The first half-circular waveguide 941 of the second module waveguide layer 92 is part of the first radiating element 1a. The second input/output port 922 of the second module waveguide layer 92 is arranged below a second half-circular waveguide 942 of the second module waveguide layer 92. The second half-circular waveguide 942 of the second module waveguide layer 92 is part of the second radiating element 1b. The third input/output port 923 of the second module waveguide layer 92 is arranged below a third half-circular waveguide 943 of the second module waveguide layer 91. The third half-circular waveguide 943 of the second module waveguide layer 92 is part of the third radiating element 1c.

In this embodiment the module waveguide layers 91, 92 have a rectangular cross section with a width of 2.5 mm and a height of 9.0 mm. As the height in this case is the larger of the two dimensions of the cross-section, the height of 9.0 mm defines the cut-off frequency f_{C}, which in this case is 16.66 GHz. In free space this is equivalent to a cut-off wavelength λ_{C} of 18 mm. As the waveguides, the radiating elements and the elements of the invention scale with the wavelength, in the following all dimensions are indicated as relative dimension with relation to the cut-off wavelength λ_{C}.

In the following the transition between a module waveguide layer to a half-circular waveguide is described with relation to a transition from the second module waveguide layer 92 to a triple 60a of radiating elements 1a, 1b, 1c. The difference to a transition from the first module waveguide layer 91 to the triple 60a of radiating elements 1a, 1b, 1c is that this transition is shorter as the first module waveguide layer is on top of the second module waveguide layer and therefore directly connected with the first module waveguide layer 91.

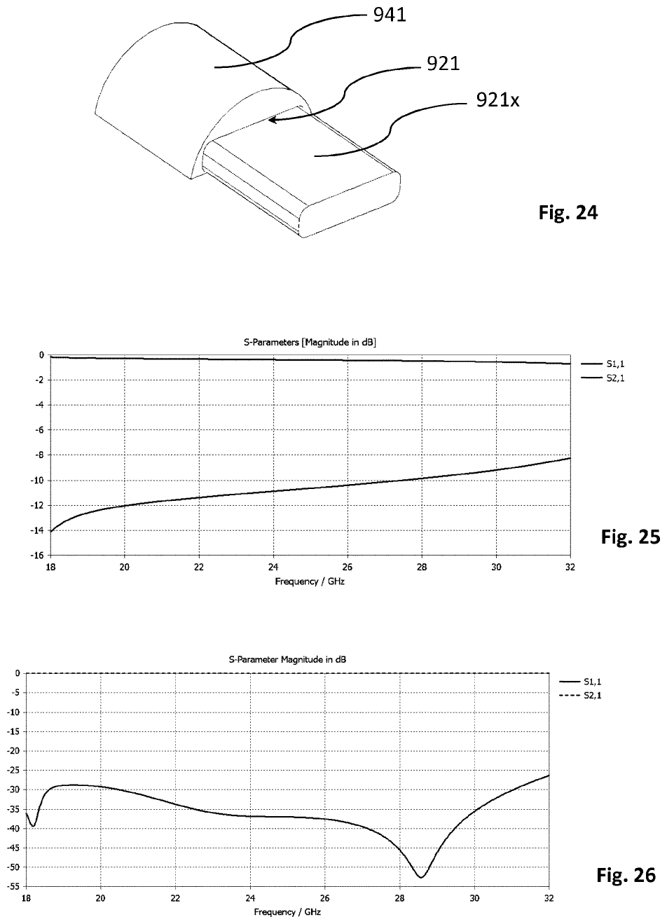

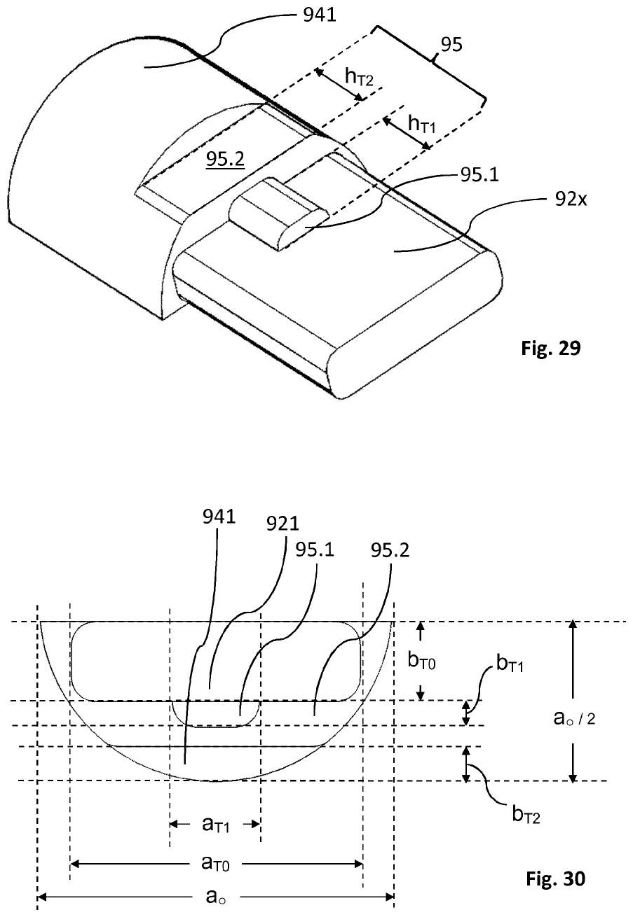

FIG. 24 shows an arrangement when a port 921 connects to a half-circular waveguide 941 of a radiating element without a transition. The S₁₁ diagram shows values between −14 dB and −12 dB. Whilst the S₁₁ value could be still acceptable for a single radiating element, when multiple elements are combined to form an array, the total S₁₁ would further degrade to unacceptable values. In addition to that the parameter S₂₁ shows an insertion loss that in the worst case is about 1 dB, and this also means a gain reduction of the same amount. Therefore the invention proposes a transition element 95 between port 921 and half-circular waveguide 941. FIG. 28 shows the air volume between a junction port 928 which connects the 4 port junction 924 with the rest of the second module waveguide layer 92 and a triple of half-circular waveguides 941, 942, 943 in a three dimensional view, including a transition element 95. FIG. 29 shows in particular this transition 95 from a port 921 to a half-circular waveguide 941. FIG. 30 shows the same transition 95 from below. The transition 95 is crucial to avoid mismatches over the whole waveguide distribution unimodal bandwidth.

The port 921, apart from that it is a perpendicular continuation of the module waveguide layer 92 has the same dimensions as the module waveguide layer 92, i.e. a length of a_{T0}=0.5λ_{C} between its broader side walls and a width of b_{T0}=0.14λ_{C} between its narrower side walls. The transition 95 enlarges in a first vertical section the cross section of the port 921 by a convexity 95.1. In a second vertical section the transition 95 reduces the cross section of the half-circular waveguide 941 by an incision 95.2. Thus the transition adapts the cross section of the port 921 to the cross section of the half-circular waveguide 941 in two steps. To be precise, the convexity 95.1 is on the same side of the port 921 as the circular shaped wall of the half-circular waveguide 941. The convexity 95.1 protrudes about h_{T1}=0.18λ_{C}. Its broader wall is parallel to the broad wall of the port 921 and is about a_{T1}=0.15λ_{C} and its narrower wall is about b_{T1}=0.04λ_{C}. This convexity 95.1 may have a rectangular cross section. Due to the manufacturing the convexity 95.1 in this embodiment has rounded edges.

Along the bottom of the half-circular waveguide 941 the incision 95.2 extends parallel to the septum and cuts off a segment of the circular wall of the half-circular waveguide 941. The thickness b_{T2} of the sector that is cut off is about b_{T}2=0.06λ_{C}. The incision 95.2 reduces the cross section of the lower part of the of the half-circular waveguide 941 over a height h_{T2}=0.17λ_{C}. Convexity 95.1 and incision 95.2 allow for a stepped transition from the rectangular cross section of the port 921 to the half-circular cross section of the half-circular waveguide 931. The transition 95.1, 95.2 is fully matched, being the S₁₁ parameter of this transition about −30 dB and the parameter S₂₁ very close to 0 dB.

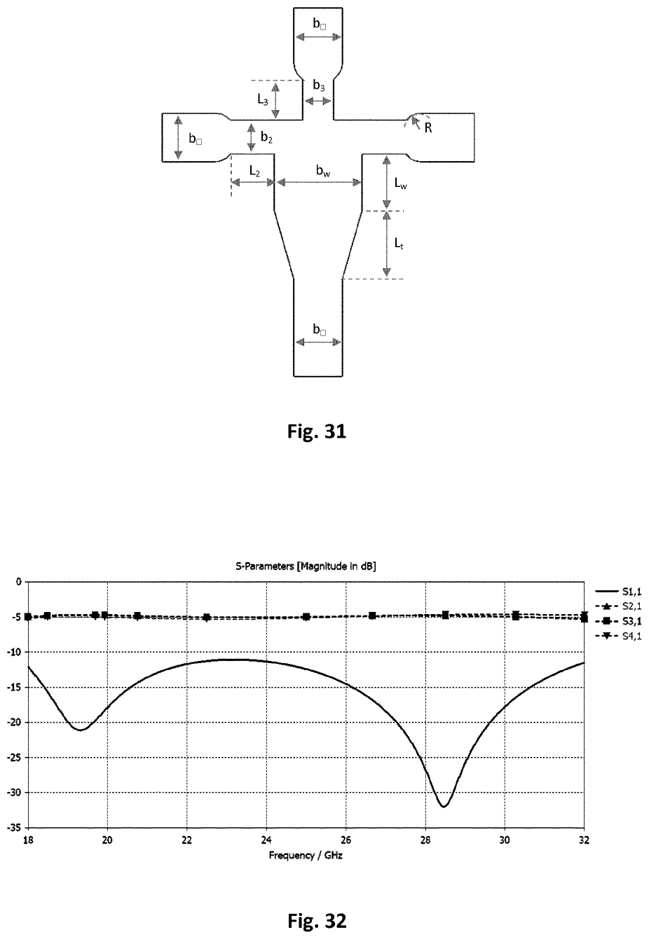

FIG. 31 shows in a view on the E-plane a 3-way power divider/combiner. The 3-way power divider/combiner presents a cross-like E-plane cross-section. When considered as a divider, the input waveguide is located in the bottom side of the longer arm of the cross, and it is connected to a common chamber where all the other output waveguides originate, the connections to this common chamber being realized with waveguide sections with proper lengths and heights, such that optimum matching is guaranteed over the operative frequency band of interest. A dual-band performance or a broad-band performance with two sub-bands with optimum performance is obtained thanks to a two-step matching, realized (i) by a proper tapering of the waveguide section connecting the input waveguide to the common chamber, and (ii) by a properly reduced height of the waveguide sections connecting the three outputs to the common chamber, each of the above features acting as impedance transformers whose lengths are properly selected in order to produce a dual-band behaviour.

The table below shows the dimensions of the geometrical form of the 3-way power divider/combiner in a second column absolute measurements and in a third column relative measurements in relation to the cut-off wavelength λ_{c} that has been chosen for the module waveguide layers 91, 92.

| | | |
|---|---|---|
| a_{□} | 9.00 mm | 0.500 λ_{c} |
| b_{□} | 2.50 mm | 0.139 λ_{c} |
| b₂ | 1.75 mm | 0.097 λ_{c} |
| b₃ | 1.60 mm | 0.089 λ_{c} |
| L₂ | 2.25 mm | 0.125 λ_{c} |
| L₃ | 2.10 mm | 0.117 λ_{c} |
| L_{w} | 2.90 mm | 0.161 λ_{c} |
| Lₜ | 3.50 mm | 0.194 λ_{c} |
| R | 1.00 mm | 0.056 λ_{c} |

FIG. 32 shows the optimized performance of a 3-way power divider/combiner designed to operate in the RX and TX Ka bands. Optimum matching is exhibited both in the 18-21 GHz and in the 28-31 GHz frequency ranges, and equal power division is also obtained on the same bands.

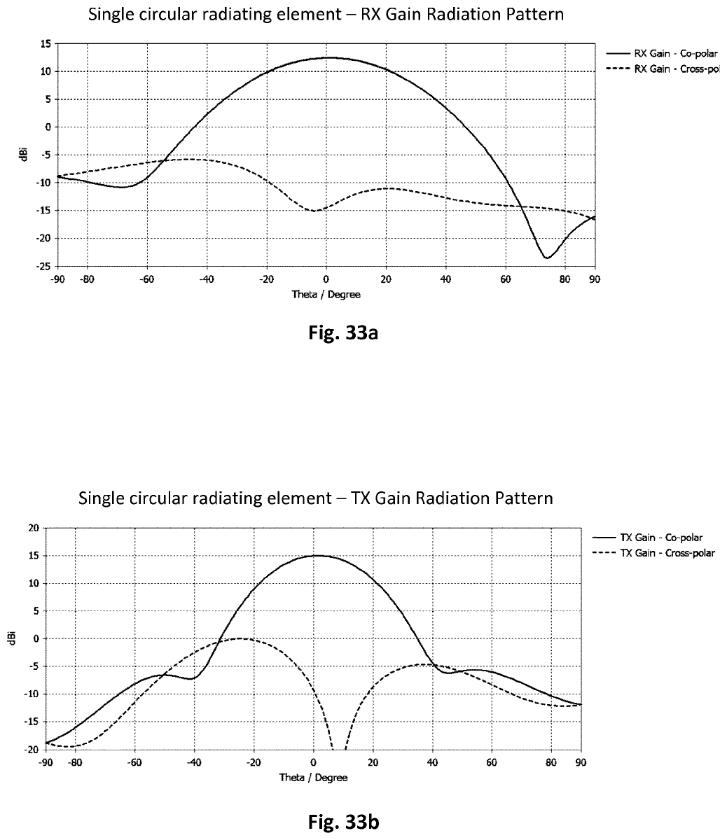

FIG. 33a shows the realized gain of a single circular horn in the RX band at 20 GHz in dBi, including the effect of the gain-enhancing screen, having a triangular septum with an optimized opening. The graph with the solid line reflects the gain for a typical co-polar plotted over the off-axis Theta. The dashed graph shoes a cross-polar gain plotted again over the receiving angle Theta. FIG. 33b shows similarly to FIG. 33a co-polar realized gain as a graph with a solid line and cross-polar gain as a graph with a dashed line in the TX band at 30 GHz, plotted over the off-axis angle. Again this diagram includes the effect of the gain-enhancing screen and a triangular septum with an optimized opening.

Modular Concept

In order to communicate with a satellite an antenna arrangement has to achieve a certain sensitivity to detect an input signal at minimal signal amplitude at a specific signal-to-noise ratio, S/N ratio. The specific signal-to-noise ratio herby is a function of the channel code in which the signal was encoded before transmission. In general, for satellite communication a single antenna module 6 will not achieve this minimum signal-to-noise ratio, although other application, for example RADAR applications may suffice with one antenna module 6. However, as mentioned before, the number of twenty-four radiating elements per antenna module 6 was chosen to allow for an easy-to-handle size of the module 6 and to avoid more than two beam forming network layers in a module 6.

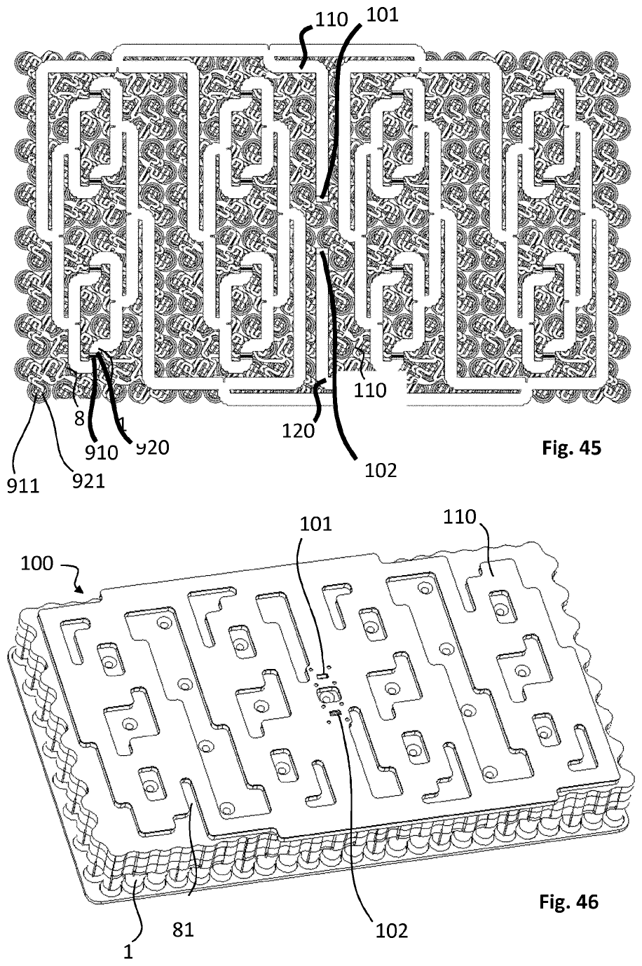

In order to assemble an antenna with a sufficient number of radiating elements 1 the antenna modules 6 may be arranged in any number and any shape. In the following, an arrangement of m antenna modules 6 placed with their longer sides to each other, and n antenna modules 6 placed with their shorter sides to each other this will be called a m times n array. The antenna array 9 shown in FIG. 41 therefore is a two times one array, 2×1, resulting in a lattice of eight times six radiating elements 1. If two antenna modules 6 would be placed with their shorter sides together, this would be named a one times two array, 1×2, resulting in a lattice of four times twelve radiating elements 1. FIG. 45 for example shows a four times four array, 4×4, resulting in sixteen times twenty-four radiating elements 1. This terminology is a matter of convention only and could be the other way around.

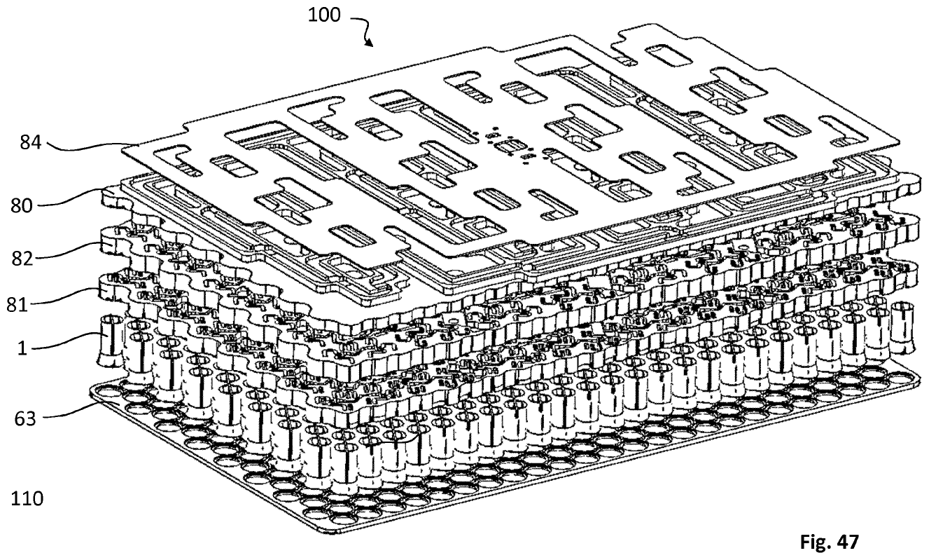

The idea behind a module 6 is that it can be easily arranged to antenna arrays of any desired size. A great advantage hereby is that for each desired size only the base beam forming plate 7 needs to be adapted to mechanically accommodate the modules 6 and to electrically communicate all modules with a first central port 710 via a first and a second central port 720 provided by the base beam forming plate 7. For this purpose the bottom part of the base beam forming plate 7 comprises a first array waveguide network 71 which connects the first central port 710 with all first module ports 61. Similarly, the bottom part of the base beam forming plate 7 further comprises a second array waveguide network 72 which connects the second central port 720 with all second module ports 62. As the first array waveguide network 71 and the second array waveguide network 72 only distribute the microwave signals between modules but not within a module, they find sufficient space to be arranged in a single layer. Thanks to the size of a module 6 with twenty-four radiating elements 1 the available space even allows for arranging the waveguides such that the waveguide's H-plane is parallel to the horizontal plane x-y of the base beam forming plate 7. As a consequence the wider part of the waveguides cross-section runs parallel to the plane of the horizontal plane x-y of the base beam forming plate 7 and the narrower part of the waveguides cross-section extends perpendicular to the plane of the horizontal plane x-y of the base beam forming plate 7. Thanks to the smaller vertical extension of the waveguide in the vertical direction z the grooves for the array waveguide layer are only 2.5 mm in height. AS the grooves of the first array waveguide network 71 and the second array waveguide network 72 only need a pure cross section, no counter plate is needed and the grooves of the array waveguide layer can be closed by a simple plain plate, termed in the following as a lid. As FIG. 47 shows such a lid needs only two perforations to allow access for the first central port 710 and the second central port 720.

In a single module 6, as it is presented in FIG. 20 we can see that the base beam forming plate 80 does not have to accommodate grooves of an array distribution network does not need a lid. The bottom part of the base beam forming plate 80 practically forms the lid for the second module waveguide layer 92. Obviously the base beam forming plate 80 needs openings to allow vertical passages to the first module port 61 of the first beam forming layer 91 and to the second module port 62 of the second beam forming layer 92. Actually, by vertically extending the first module port 61 and to the second module port 62 the openings on the bottom side of the beam forming plate 80 become the first beam forming port 61 and to the second module port 62. Thus a single module is self-contained. A plurality of self-contained single modules 6 may be arranged into an antenna array with waveguide distribution means to connect the openings of the beam forming plates 80, but this would be a waste of space and weight.

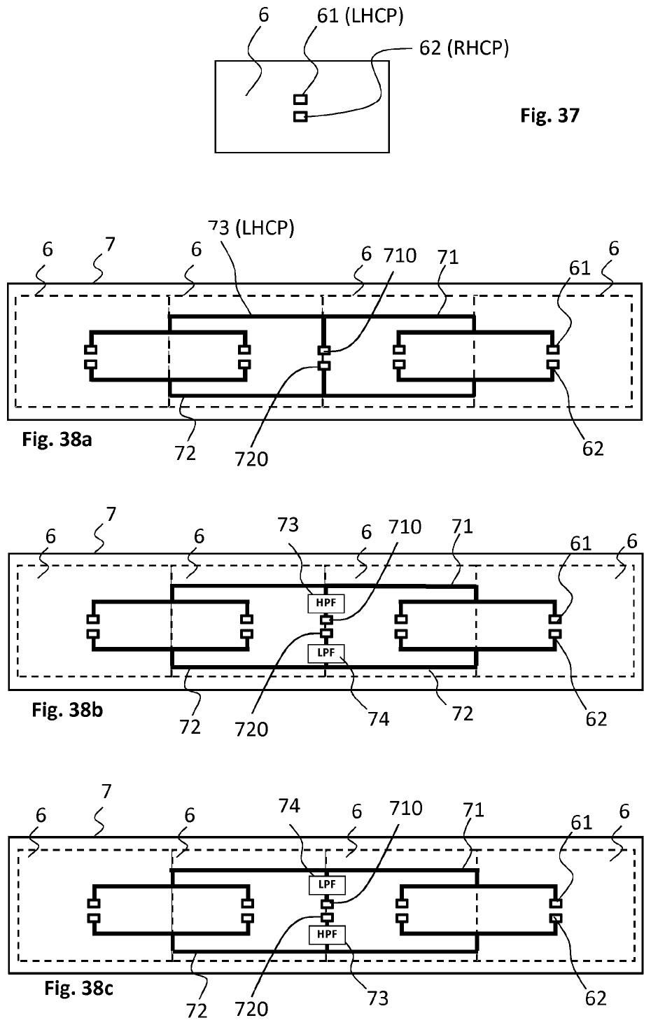

In the following this modular concept is presented schematically in various embodiments. In the schematic embodiments a module is represented by a schematic symbol as shown in FIG. 37. This symbol shows the shape of a module 6 as a rectangular with a first module port 61 and a second module port 62. With regard to the internal communication of the first module port 61 with all first half circular waveguides 21 the first module port 61 is associated with LHCP. Consequently, the second module port 61 communicates with all second half circular waveguides 22 and therefore is associated with RHCP. This is just a matter of convention and it can be also the other way around.

The schemes of FIG. 38 show the four modules 6 with a dashed outline to distinguish the shape of the modules 6 from the one piece base beam forming plate 4. For the purpose of illustration the outline of the base beam forming plate 7 is depicted slightly bigger than the contour of the combined modules 6. For practical reasons base beam forming plate 7 and modules 6 would be chosen to be congruent to each other. FIG. 38a shows as an example an arrangement with four modules 6 arranged with their small sides next to each other in a single row. This creates an antenna array of twenty-four times four radiating elements 1.

The first array waveguide network 71 and the second array waveguide network 72 are represented by thick lines. The first array waveguide network 71 is connected to the first central port 710 and then forks of by a 2-way power divider/combiner perpendicular to the left hand side and the right hand side. From each side first array waveguide network 71 forks of by further 2-way power divider/combiners a second time. Each forked of end then connects to the four first module ports 61 of the four modules 6. Similarly the second array waveguide network 72 connects the second central port 720 with the four second module ports 62 of the four modules 6.

In the example shown in FIG. 38a the first array waveguide network 71 and the second array waveguide network 72 simply connect the respective first module ports 61 and second module ports 62 physically without any additionally electrical function. Each port 710 and 720 is associated with an orthogonal circular polarization and covers the whole RX and TX frequency band. In other words, we have a simultaneous dual-polarized dual-band antenna. How these polarizations are used in TX and RX modes only depends on the additional circuitry that may connect to ports 710 and 720. The following FIGS. 40b, 40c, etc. show some examples.

FIG. 41b shows as a schematic drawing a module 6 with a high-pass filter 73 inserted in the first array waveguide network 71 between the first array input/output port 710 and before the first input/output signal is split respectively combined for the first time. Similarly, a low-pass filter 74 is inserted in the second array waveguide network 72 between the second array input/output port 720 and before the second input/output signal is split, respectively combined. The low-pass filter 74 and the high-pass filter 73 are integrated in the base beam forming plate 7. In FIG. 38b the high-pass filter 73 is in the first array waveguide network 71 and therefore in the LHCP waveguide network. The low-pass filter 72 is in the second array waveguide network 71 and therefore in the RHCP waveguide network. This embodiment enables to transmit signals in LHCP, and to receive signals in RHCP.

The integration of the low-pass filter 74 and the high-pass filter 73 also provides an advantage in that by rotating the base beam forming plate by 180 degrees, as shown in schema of FIG. 38c the high-pass filter 73 is now in the second array waveguide network 72 and the low-pass filter 74 is now in the first array waveguide network 71. This embodiment enables to transmit signals in RHCP, and to receive signals in LHCP.

As indicated by FIGS. 38b and 40c the polarization in TX and RX can be selected by mechanically/manually rotating the base beam forming plate 7. Alternatively the base beam forming plate 7 may be manufactured as two pieces. A first piece with the first array waveguide network 71 and the second array waveguide network 72 and a second piece with the integrated low-pass filter 74 and the high-pass filter 73. Thus only the second piece, i.e. a much smaller piece of the base beam forming plate 7 has to be rotated in order to change the polarization in transmit band TX and receive band TX.

In case the LHCP/RHCP orientation should be changed during operation, an electro-mechanical device may actuate the second piece of the wave plate in a first position and a second position. The first position would then result in a configuration as shown in FIG. 38b and the second position would result in a configuration as shown in FIG. 38c.

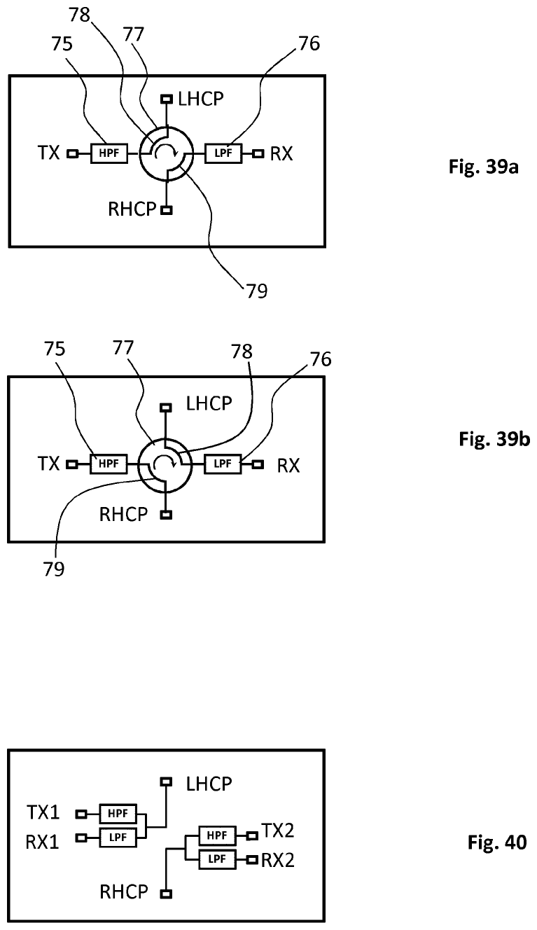

A preferred embodiment of a electromechanical switch is presented in the scheme of FIG. 39. In case the LHCP/RHCP orientation should be changed quickly during operation, an electro-mechanical waveguide switch 77 can be inserted between the LHCP input/output port, the high-pass filter, the low-pass filter and the RHCP input/output port. The switch has two waveguide segments which can be actuated in a first position and a second position. In a first position, which is shown in FIG. 39a the LHCP input/output port is connected by a first waveguide segment 78 of waveguide switch 77 with the high-pass filter 73 and the RHCP input/output port is connected by a second waveguide segment 79 of waveguide switch 77 with the low-pass filter 74 When the switch is actuated into the second position, which is shown in FIG. 39b the first waveguide segment 78 is rotated by 90° and connects now the LHCP input/output port with the low-pass filter 74 Similarly, the second waveguide segment 79 is rotated by 90° and now connects the RHCP input/output port with the high-pass filter 73 Thus the polarization in TX and RX can be selected by means of the electro-mechanical waveguide switch 77, rotating with 90-deg steps.

In another example shown in FIG. 40 each polarization is connected to a diplexer, made of a low-pass filter 74 and a high-pass filter 73. The two outputs of each diplexer are connected to the receiving ports RX1, RX2 and transmitting ports TX1, TX2 of two independent transceivers, which can simultaneously use the antenna array to both transmit and receive on both polarizations.

As it has been demonstrated by the various embodiments the whole antenna aperture is used to simultaneously radiate in both polarizations and over both the RX and TX frequency bands. Simultaneous dual-polarization TX and RX is also possible with four physical ports.

The proposed antenna finds application on satellite communication systems, though the same architecture may also be employed on data-link communication as well as radar systems, or any other applications requiring simultaneous dual polarization performance over wide bandwidths.

2×1-Module Antenna Design with Integrated Filters

FIG. 41 shows an embodiment of a 2×1 antenna array 9, which is composed of two identical antenna modules 6, a first antenna module 6′ and a second antenna module 6″. The two antenna modules 6′, 6″ are placed with their longer side of six radiating elements next to each other so that this antenna array results in a lattice of radiating elements 1 arranged in eight rows with six radiating elements 1 per row. The housing of the antenna modules 6 are shaped such that when the two antenna modules 6′, 6″ are arranged next to each other they interlock like a jigsaw puzzle with regular formed pieces.

In order to mechanically connect the first modules 6′ with the second module 6″, the second beam forming plate 82 may have protrusions 85, which correspond with indentations 86 of the second beam forming plate 82 when two modules 6 are placed with their long sides or the short sides to each other. The indentations 86 of the second beam forming plate 82 creates with the base beam forming plate 80 below the indentation 86 and the first beam forming plate 81 above the indentation 86 a cavity into which the corresponding protrusions 85 are inserted. Each protrusion 85 has a bore 87 which corresponds to a through hole 88 of the base beam forming plate 80 which are in line when the protrusions are inserted to the indentations 85. The bore 87 may be threaded to allow a screw inserted to the through hole 88 to mechanically connect neighboured modules 6, or alternatively connect them with rivets. In order to increase mechanical stability a single top plate 63 connects the two modules 6′, 6″. As the top plate 63 is only a relatively thin metal plate with the horn extensions 632 it may be easily produced in any size without deviating from the modular concept. The top plate 632 is firmly connected by screws or rivets 633 to the two antenna modules. A bottom lid, which is not visible in this drawing, stretches over the bottom of the base beam forming plate 80 of the two modules 6′, 6″ and in addition to the top plate mechanically connects the two modules 6′, 6″ on their bottom sides. As FIG. 42 illustrates a gain-enhancing plate 64 may be placed on top of the top plate 63 in order to further improve the antenna gain.

Again, in this case the gain-enhancing plate spans over the full top surface of the two modules 6′, 6″.

Alternatively the implementation of the 2×1 array module shown in FIG. 41 may be realized by merging the physical structures of each plate of the two modules in a single plate so that each beam forming plate 81, 82 and base beam forming plate 80 is made of a single piece.

While in FIG. 19 the detail labelled with 85 is actually a protrusion intended for interlocking, the details labelled 85 in FIGS. 41 and 44 have another function, as interlocking is not needed in case the 2×1 array is the final size. Those protrusions are for connecting the antenna to an external turning unit. In other words, that is a mechanical interface for the tracking system. And of course this can be customized. Its position is not affecting RF performance.

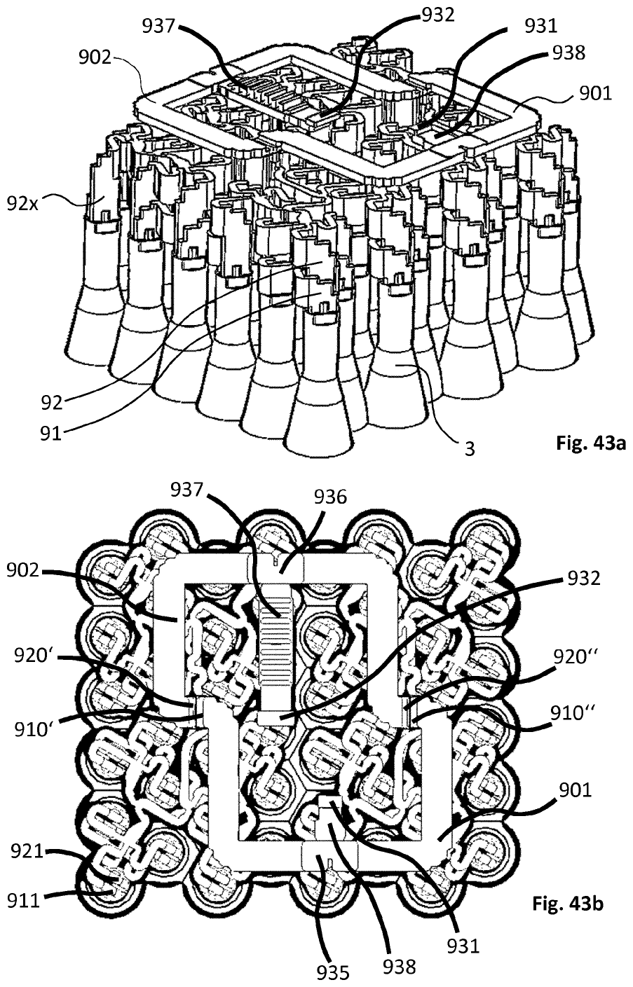

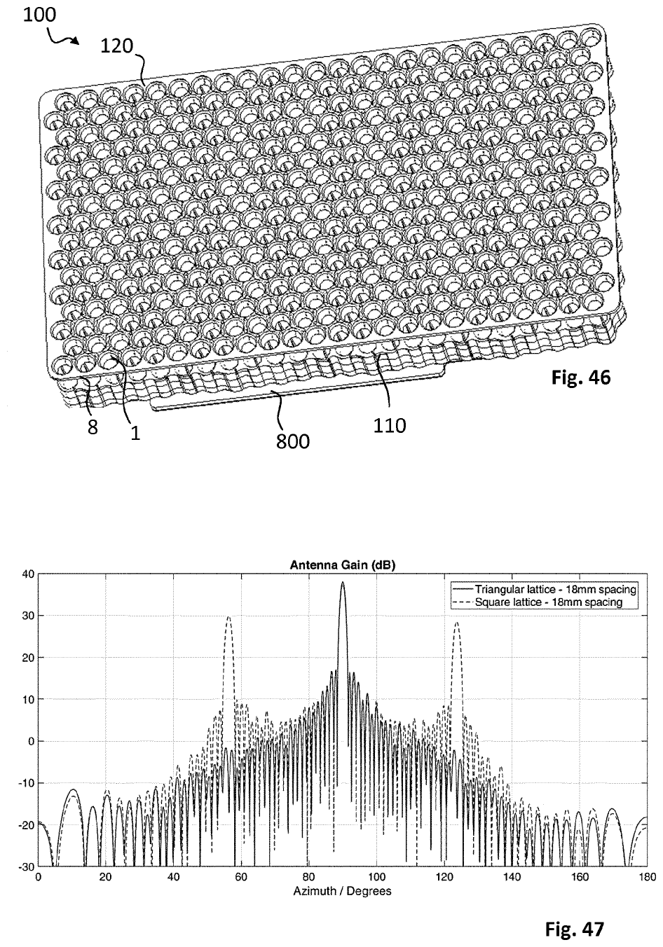

FIG. 45a shows a three dimensional view of the air volume of the 2×1 antenna array 9. FIG. 43b shows the same air volume in a two-dimensional view by looking at the bottom of the 2×1 antenna array 9. A first distribution waveguide 901 is arranged at the bottom plate 800 and connects a first 2×1 antenna array input port 931 with a first module input/output port 910′ of the first module 6′ and a first module input/output port 910″ of the second module 6″. A first distribution splitter/combiner 935 splits, respectively combines the signals distributed in this first distribution waveguide 901. A second distribution waveguide 902 is also is arranged at the bottom plate 800 and connects a second 2×1 antenna array input port 932 with a second module input/output port 920′ of the first module 6′ and a second module input/output port 920″ of the second module 6″. A second distribution splitter/combiner 936 splits, respectively combines the signals distributed in this second distribution waveguide 902. As explained already above, due to the size of the modules 6′, 6″ the first distribution waveguide 901 and the second distribution waveguide 902 fit into a single layer, the array waveguide layer 90. Due to the larger space that is available the first distribution waveguide 901 and the second distribution waveguide 902 are orientated such that the waveguide walls with the smaller distance extend in vertical direction and the waveguide walls with the wider distance extend parallel to the plane of the array waveguide layer. Thus the waveguide distribution 901 and 902 are arranged horizontally, or in the H-plane respectively and the array waveguide layer can be much thinner than the first plate 81, the second plate 82 and the base beam forming plate 80.

Advantageously this allows for accommodation of the third waveguide layer completely in the bottom part of the base beam forming plate 80. The open structures of the third waveguide layer simply have to be covered with a bottom lid. This makes it necessary, for example to machine the structures on the bottom part of the base beam forming plate 80 of the first module 6′ differently to the base beam forming plate 80 of the second module 6″. On the other hand the proposed solution improves the total weight of an antenna array significantly and still is less expensive to produce due to the other re-useable parts of the modules 6.

The array waveguide layer is realized in the bottom plate 800 below the base beam forming plate 80, or integrated on the back face of base beam forming plate 80. And in both cases the base beam forming plate 80 (as well as first plate 81 and second plate 82) and the array waveguide layer 90 are made of a single piece.

In addition to the waveguide distribution the embodiment in FIG. 43a shows that the first distribution waveguide 901 and the second distribution waveguide 902 include structures which represent an integrated high-pass (RX) filter 938 and band-pass (TX) filter 937 respectively. From FIG. 43a and FIG. 43b it is difficult to see, that the high-pass filter 938 is realized by a cross-circuit section the width of which is narrower than the width a, of the waveguides of the module waveguide layers. This narrow cross-circuit section 938 raises the cut-off frequency and attenuates in both directions microwave signals that are below this raised cut-off frequency. The integrated high-pass (RX) filter 938 and the integrated band-pass (TX) filter 937 enable respectively the signals with a frequency in the transmit range of 28 GHz-31 GHz to pass from the second module input/output port 910′ of the first module 6′ and from the second module input/output port 910″ of the second module 6″ to the first 2×1 antenna array input port 931 and the signals with a frequency in the receive range of 18 GHz-21 GHz to pass from the second module input/output port 920′ of the first module 6′ and from the second module input/output port 920″ of the second module 6″ to the second 2×1 antenna array input port 932. Thus all second half-circular waveguides 22 of all radiating elements 1 of the first module 6′ and the second module 6″ are adapted to work as receiving radiating antenna elements and all first half-circular waveguides 21 of all radiating elements 1 of the first module 6′ and the second module 6″ are adapted to work as transmitting radiating antenna elements.

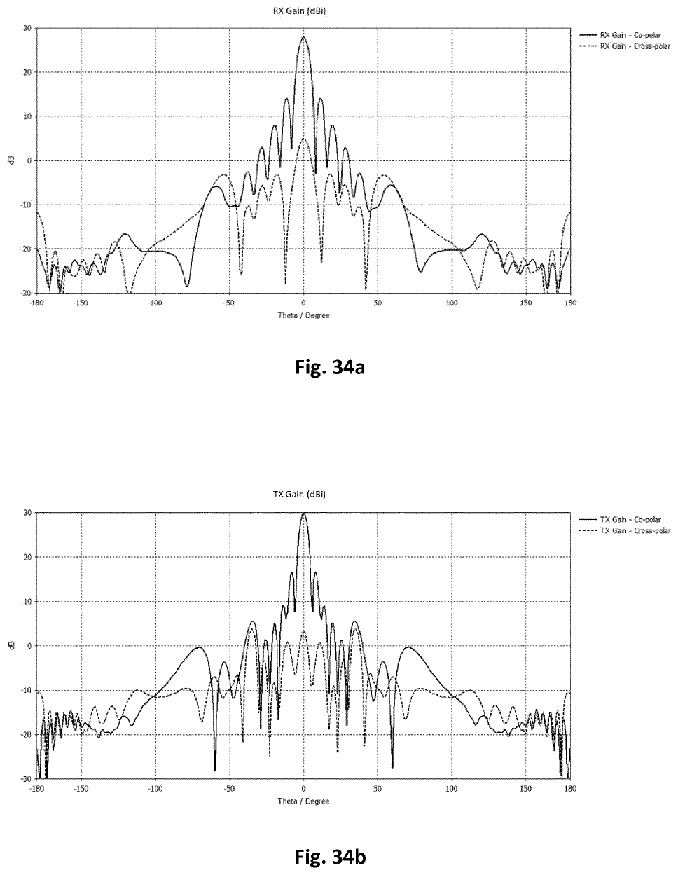

FIG. 34a shows the realized gain in dBi for a 2×1 module 9 in the RX band. The graph with the solid line reflects the gain for a typical Co-polar plotted over the off-axis Theta. The dashed graph shoes a cross-polar gain plotted again over the receiving angle Theta. FIG. 34b shows similarly to FIG. 33a co-polar gain as a graph with a solid line and cross-polar gain as a graph with a dashed line in the TX band, plotted over the off-axis angle. Again, prior art radiating elements would show this performance together with a good Return Loss and Isolation performance, without changing the geometry of the radiating elements only in the RX (18 GHz-21 GHz) or TX (28 GHz-31 GHz) range.

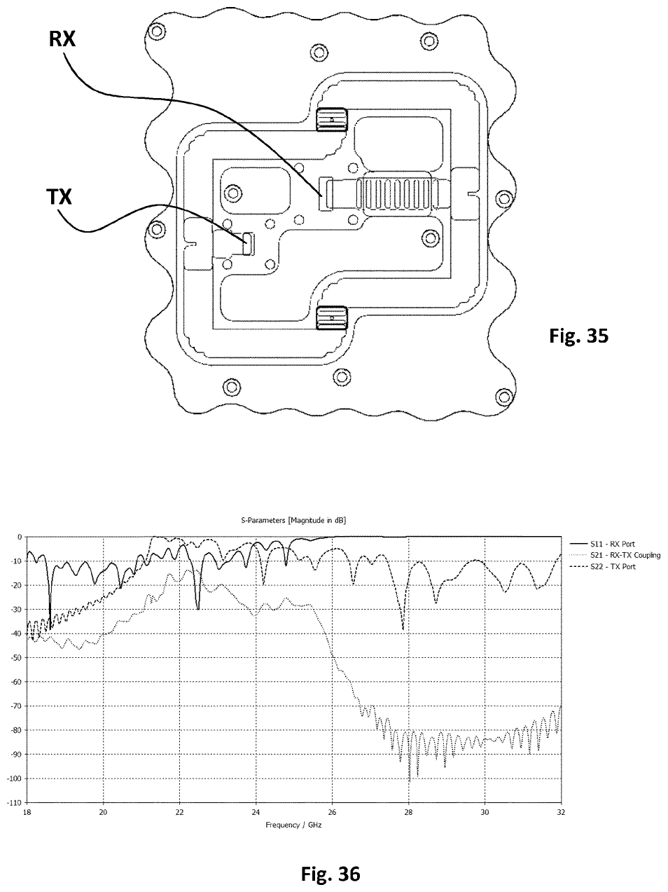

FIG. 35 shows the bottom plate without its lid to show its internal geometry. The array waveguide layer is realized in the bottom plate as a separate component in all cases where the ability to switch the RX and TX polarizations is to be maintained/guaranteed. The polarization switch can be obtained by simply rotating the bottom plate by 180 deg in a manual or automated manner.

FIG. 36 shows the Antenna Performance of the described 2×1 antenna array 9. The Return Loss at RX port is depicted as a solid line, Return Loss at TX port is depicted as a dashed line and RX-TX coupling is depicted as a dotted line. The performance is equivalent to prior art which would have to use separate antenna arrays for RX and TX. As explained, the advantage of the septum geometry allows for accommodating a receiving antenna and a transmitting antenna in a single antenna array 9.

4×4-Module Antenna Design

In another embodiment of the invention shown in FIG. 44 more than two modules 6 are arranged to a 4×4 antenna array 100. All module ports 910, 920 of an antenna array 100 are supplied from antenna array ports 101, 102 by a single physical module waveguide layer 93, comprising a first distribution waveguide network 110, connecting the first array port 101 with each first module input/output ports 910, and a second distribution waveguide network 120, connecting the second array port 102 with each second module input/output ports 920. This third waveguide layer is termed antenna array waveguide layer as it spans over a complete antenna array 100, whatever the size of the antenna array 100 will be. FIG. 45, showing the antenna array waveguide layer as an air volume from the bottom, illustrates that the antenna array waveguide layer accommodates the first distribution network 110 and the second distribution network 120 in one physical layer. As already described with respect to the 2×1 antenna array 9, the antenna array waveguide layer 90 of the 4×4 antenna array 100 fits into the bottom part of the base beam forming plates 80. As can be seen from the air volume of FIG. 45 the antenna waveguide layer has a lot of empty space in-between the array waveguide waveguides. For this reason the bottom lid 110 does not have to cover the whole bottom area created by the sixteen first network beam forming plates 81 of the 4×4 antenna array 100. This again saves weight.

As can be seen from FIG. 38a, 40b, 40c the three embodiments of the 2×1 antenna array 9, a 4×4 antenna array 100 and the 1×4 antenna array 7 the antenna modules can be arranged and combined to realize any aperture size that is needed for a specific application. The whole aperture is used simultaneously on both polarizations, and therefore simultaneous reception and transmission using the whole aperture is possible. Prior art antenna systems operating at Ka-band make use of two separate apertures, mainly due to the large frequency separation between the RX and TX frequency bands. In comparison with prior art systems the proposed solution allows for a large size reduction given a required gain or a larger gain given a maximum allowed antenna size.

The detailed description set forth above in connection with the appended drawings describes exemplary embodiments and does not represent the only embodiments that may be implemented or that are within the scope of the claims. The term “example” used throughout this description means “serving as an example, instance, or illustration,” and not “preferred” or “advantageous over other embodiments.” The detailed description includes specific details for the purpose of providing an understanding of the described techniques. These techniques, however, may be practiced without these specific details. In some instances, well-known structures and devices are shown in block diagram form in order to avoid obscuring the concepts of the described embodiments.

Information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The functions described herein may be implemented in various ways, with different materials, features, shapes, sizes, or the like. Other examples and implementations are within the scope of the disclosure and appended claims. Features implementing functions may also be physically located at various positions, including being distributed such that portions of functions are implemented at different physical locations. Also, as used herein, including in the claims, “or” as used in a list of items (for example, a list of items prefaced by a phrase such as “at least one of” or “one or more of”) indicates a disjunctive list such that, for example, a list of “at least one of A, B, or C” means A or B or C or AB or AC or BC or ABC (i.e., A and B and C).

As used in the present disclosure, the term “parallel” is not intended to suggest a limitation to precise geometric parallelism. For instance, the term “parallel” as used in the present disclosure is intended to include typical deviations from geometric parallelism relating to such considerations as, for example, manufacturing and assembly tolerances.

Furthermore, certain manufacturing process such as molding or casting may require positive or negative drafting, edge chamfers and/or fillets, or other features to facilitate any of the manufacturing, assembly, or operation of various components, in which case certain surfaces may not be geometrically parallel, but may be parallel in the context of the present disclosure.

Similarly, as used in the present disclosure, the terms “orthogonal” and “perpendicular”, when used to describe geometric relationships, are not intended to suggest a limitation to precise geometric perpendicularity. For instance, the terms “orthogonal” and “perpendicular” as used in the present disclosure are intended to include typical deviations from geometric perpendicularity relating to such considerations as, for example, manufacturing and assembly tolerances. Furthermore, certain manufacturing process such as molding or casting may require positive or negative drafting, edge chamfers and/or fillets, or other features to facilitate any of the manufacturing, assembly, or operation of various components, in which case certain surfaces may not be geometrically perpendicular, but may be perpendicular in the context of the present disclosure.

As used in the present disclosure, the term “orthogonal,” when used to describe electromagnetic polarizations, is meant to distinguish two polarizations that are separable. For instance, two linear polarizations that have unit vector directions that are separated by 90 degrees can be considered orthogonal. For circular polarizations, two polarizations are considered orthogonal when they share a direction of propagation, but are rotating in opposite directions.

The previous description of the disclosure is provided to enable a person skilled in the art to make or use the disclosure. Various modifications to the disclosure will be readily apparent to those skilled in the art, and the generic principles defined herein may be applied to other variations without departing from the scope of the disclosure. Thus, the disclosure is not to be limited to the examples and designs described herein but is to be accorded the widest scope consistent with the principles and novel features disclosed herein.

1-15. (canceled)

16. A microwave antenna system, comprising:
a plurality of radiating elements, wherein each of the plurality of radiating elements is in connection with at least one element feed port; and
a waveguide system with power divider/combiners that connects at least one system feed port with the at least one element feed port of the plurality of radiating elements,
wherein the plurality of radiating elements is grouped in triangular groups of three radiating elements, the radiating elements of each triangular group forming a triangle and the at least one element feed port of each radiating element of each triangular group is individually fed by a three-way power divider/combiner of the waveguide system.

17. The microwave antenna system of claim 16, wherein a plurality of the triangular groups of radiating elements is arranged in a triangular lattice.

18. The microwave antenna system of claim 16, wherein the three-way power divider/combiner has in the form of a cross with a longer bar intersecting essentially perpendicular to a shorter bar, with one input waveguide located at one end of the longer bar, a first output waveguide being located at the other end of the longer bar, a second output waveguide being located at one end of the shorter bar and a third output waveguide being located at the other end of the shorter bar, wherein a middle section of the cross widens from the one end of the longer bar towards the shorter bar.

19. The microwave antenna system of claim 16, wherein each radiating element has a horn, the system comprising a top plate is arranged on top of the plurality of radiating elements and extends each horn of the radiating elements in axial direction.

20. The microwave antenna system of claim 19, wherein a gain-enhancing plate is arranged on top of the top plate, further extending the horns of the radiating elements in axial direction, so that apertures of the extended horns to at least partially overlap.

21. The microwave antenna system of claim 16,
wherein each of the radiating elements comprises a first section and a second section;
wherein each of the at least one element feed ports comprises a first element feed port and a second element feed port;
wherein each first element feed port is in connection with the first section of each of the radiating elements and each second element feed port is in connection with the second section of each of the radiating elements;
wherein
the waveguide system comprises a first waveguide system separate from a second waveguide system, and
the at least one system feed port comprises a first system feed port and a second system feed port; and
wherein the first waveguide system connects the first system feed port with the first element feed ports and the second waveguide system connects the second system feed port with the second element feed ports.

22. The microwave antenna system of claim 21, comprising:
a first plate;
a second plate connected to the first plate beneath the first plate; and
a base plate connected to the second plate beneath the second plate;
wherein the first plate has mounting holes in a top of the first plate mounting the radiating elements, wherein the first section of each radiating element is above the first element feed ports and the second section of each radiating element is above the second element feed ports.

23. The microwave antenna system of claim 22, wherein the first plate comprises:
first through holes that connect the first element feed ports with first grooves which extend horizontally on a bottom of the first plate; and
second through holes that extend vertically from the second element feed ports to the bottom of the first plate.

24. The microwave antenna system of claim 23, wherein the second plate has second grooves in a top part of the second plate, which correspond with the first grooves of a bottom part of the first plate, wherein the bottom part of the first plate is on the top part of the second plate, the first grooves and second grooves thereby forming a first waveguide distribution layer.

25. The microwave antenna system of claim 24, wherein the second plate comprises third through holes which correspond with the second through holes of the first plate, thereby forming vertical passages through the first waveguide distribution layer.

26. The microwave antenna system of claim 25, wherein the bottom part of the second plate comprises third grooves which correspond with fourth grooves on a top part of the base plate, wherein the bottom part of the second plate is on the top part of the base plate, the third grooves and the fourth grooves thereby forming a second waveguide distribution layer.

27. A plurality of microwave antenna systems according to claim 26 arranged on a single array plate to form a microwave array,
wherein fifth grooves on a bottom of the single array plate accommodate a first waveguide system connecting first system feed ports of the plurality of microwave antenna systems with a first array port, and
wherein sixth grooves on the bottom of the single array plate accommodate a second waveguide system connecting the second system feed ports of the plurality of microwave antenna systems with a second array port.

28. The microwave antenna system of claim 21, wherein:
the first section of each radiating element is connected via a first transition element with the first element feed port, and
the second section of each radiating element is connected via a second transition element with the second element feed port, the first and second transition elements comprising half-circular waveguides, each with a cross section that is a half of a circle.

29. The microwave antenna system of claim 28, wherein, for each of the first transition element and the second transition element, in a first transition section of the transition element the cross-section of the element feed port is enlarged by a convexity, and in a last transition section of the transition element the cross-section of the half-circular waveguide with a half of a circle cross section is decreased by an incision, whereby a cross-section area of the last transition section of the transition element is larger than the cross-section area of the first transition section of the transition element.

30. The microwave antenna system of claim 29, further comprising:
a high-pass filter connected to the first waveguide system;
a low-pass filter connected to the second waveguide system; and
an electromechanical waveguide switch adapted to connect in a first switch position the first system feed port with the high-pass filter and the second system feed port with the low-pass filter, and to connect in a second switch position the first system feed port with the low-pass filter and the second system feed port with the high-pass filter.

31. A radiating element for receiving and transmitting microwave signals in a lower frequency band and a higher frequency band, the radiating element comprising:
a septum polarizer extending in axial direction of the radiating element dividing the radiating element into (i) a first section fed by a first feeding waveguide, for transmitting or receiving a frequency band in a first polarization, and (ii) a second section, fed by a second feeding waveguide, for transmitting or receiving a frequency band in a second polarization that is orthogonal to the first polarization;
wherein the first and the second feeding waveguides having a fundamental mode cut-off frequency and a higher mode cut-off frequency; and
wherein the length of the septum polarizer is so short that a stop frequency band is present which does not allow for continuous transmission or reception between the fundamental mode cut-off frequency and the higher mode cut-off frequency, whereby the fundamental mode cut-off frequency and the septum polarizer geometry are such that the stop frequency band ends below the higher frequency band.

32. The radiating element of claim 31, wherein the septum polarizer geometry adaptation comprises at least one adaption of a shape of the septum polarizer, the length of the septum polarizer, size and location of an opening in the septum polarizer.

33. The radiating element of claim 32, wherein the length of the septum polarizer is less or equal to two times the wavelength of the fundamental mode cut-off frequency.

34. The radiating element of claim 33, wherein the septum polarizer comprises an essentially triangular area and wherein a longest edge of the essentially triangular area is a segment of one of a linear, sinusoidal, polynomial, logarithmic or exponential curve.

35. The radiating element of claim 31, wherein the septum polarizer comprises an opening creating a connection between the first section and the second section, wherein a center of the opening is placed in an axial direction of the radiating element between one quarter and three quarters of the wavelength of the fundamental mode cut-off frequency.
